(19) United States
(12) Patent Application Publication
(10) Pub. No.: US 2021/0080684 A1
(43) Pub. Date: Mar. 18, 2021

(54) CAMERA MODULE AND ELECTRONIC DEVICE

(71) Applicant: LARGAN DIGITAL CO., LTD., Taichung City (TW)

(72) Inventors: Cheng-Feng LIN, Taichung City (TW); Lin-An CHANG, Taichung City (TW); Ming-Ta CHOU, Taichung City (TW)

(21) Appl. No.: 16/924,524

(22) Filed: Jul. 9, 2020

(30) Foreign Application Priority Data
Sep. 17, 2019 (TW) 108133444

(51) Int. Cl. G02B 7/09; G03B 11/00; G02B 7/02; G03B 13/36; G03B 5/00; G02B 27/64

(52) U.S. Cl. CPC G02B 7/09; G03B 11/00; G02B 7/021; G02B 13/0045; G03B 5/00; G02B 27/646; G03B 13/36

(57) ABSTRACT

A camera module includes a unitary element, an optical image lens assembly, a fixed member and a driving member. The unitary element has an object-side opening. The optical image lens assembly is disposed in a containing space and has an optical axis. The fixed member is for accommodating the unitary element and includes a base and a cover, and the cover has a through hole and is connected with the base. The driving member is for driving the unitary element to move relative to the fixed member. The unitary element includes a reverse inclined structure including at least two annular concave structures. The at least two annular concave structures are arranged in order from the object-side opening to an image side, wherein a sectional surface of each of the annular concave structures passing through the optical axis includes a valley point and two concave ends.

### RELATED APPLICATIONS

This application claims priority to Taiwan Application Serial Number 108133444, filed Sep. 17, 2019, which is herein incorporated by reference.

### BACKGROUND

### Technical Field

The present disclosure relates to a camera module. More particularly, the present disclosure relates to a camera module applied to portable electronic devices.

### Description of Related Art

Recently, portable electronic devices, such as intelligent electronic devices, tablets, etc., are developed rapidly and have been filled with the lives of modern people. Accordingly, the imaging lens module disposed on the portable electronic device is also flourished. However, as technology is more and more advanced, demands for the quality of the imaging lens module of users have become higher and higher. Therefore, not only the quality of the optical design of the imaging lens module should be improved, but the precision in manufacturing and assembling also needs to be improved.

### SUMMARY

According to one aspect of the present disclosure, a camera module includes a unitary element, an optical image lens assembly, a fixed member and a driving member. The unitary element is integrally formed by a lens carrier and a lens barrel and forms a containing space, wherein the unitary element has an object-side opening, and the object-side opening is a smallest opening of the unitary element. The optical image lens assembly is disposed in the containing space and has an optical axis. The fixed member is for accommodating the unitary element, wherein the fixed member includes a base and a cover, and the cover has a through hole and is connected with the base. The driving member is for driving the unitary element to move relative to the fixed member, wherein the driving member includes at least one magnet and at least one coil, and one of the at least one magnet and the at least one coil is disposed on the fixed member and is corresponding to another one. The unitary element includes a reverse inclined structure, the reverse inclined structure is located on an image side of the object-side opening and surrounds the optical axis, and the reverse inclined structure includes at least two annular concave structures. The at least two annular concave structures are arranged in order from the object-side opening to an image side, wherein a sectional surface of each of the annular concave structures passing through the optical axis includes a valley point and two concave ends, the two concave ends are respectively disposed on an object side and an image side of the valley point, and the valley point is located on a position farthest from the optical axis on each of the annular concave structures. The object-side opening is connected with one of the annular concave structures disposed closest to an object side, and two of the annular concave structures adjacent to each other are connected therewith. When a diameter of the object-side opening is ψ, and a total length of the unitary element along the optical axis is Z, the following condition is satisfied: 0.30<ψ/Z<0.80.

According to another aspect of the present disclosure, a camera module includes a unitary element, an optical image lens assembly, a fixed member and a driving member. The unitary element is integrally formed by a lens carrier and a lens barrel and forms a containing space, wherein the unitary element has an object-side opening, and the object-side opening is a smallest opening of the unitary element. The optical image lens assembly is disposed in the containing space and has an optical axis. The fixed member is for accommodating the unitary element, wherein the fixed member includes a base and a cover, and the cover has a through hole and is connected with the base. The driving member is for driving the unitary element to move relative to the fixed member, wherein the driving member includes at least one magnet and at least one coil, and one of the at least one magnet and the at least one coil is disposed on the fixed member and is corresponding to another one. The unitary element includes a reverse inclined structure, the reverse inclined structure is located on an image side of the object-side opening and surrounds the optical axis, and the reverse inclined structure includes at least two annular concave structures. The at least two annular concave structures are arranged in order from the object-side opening to an image side, wherein a sectional surface of each of the annular concave structures passing through the optical axis includes a valley point and two concave ends, the two concave ends are respectively disposed on an object side and an image side of the valley point, and the valley point is located on a position farthest from the optical axis on each of the annular concave structures. When a diameter of the object-side opening is ψ, a diameter of the valley point of one of the at least two annular concave structures disposed closest to an object side is ψDo, and a diameter of the valley point of one of the at least two annular concave structures disposed closest to the image side is ψDi, the following condition is satisfied: 0.0%<(ψDi−ψDo)/ψ×100%<30%.

According to another aspect of the present disclosure, a camera module includes a unitary element, an optical image lens assembly, a fixed member and a driving member. The unitary element is integrally formed by a lens carrier and a lens barrel and forms a containing space, wherein the unitary element has an object-side opening, and the object-side opening is a smallest opening of the unitary element. The optical image lens assembly is disposed in the containing space and has an optical axis. The fixed member is for accommodating the unitary element, wherein the fixed member includes a base and a cover, and the cover has a through hole and is connected with the base. The driving member is for driving the unitary element to move relative to the fixed member, wherein the driving member includes at least one magnet and at least one coil, and one of the at least one magnet and the at least one coil is disposed on the fixed member and is corresponding to another one. The unitary element includes a reverse inclined structure, the reverse inclined structure is located on an image side of the object-side opening and surrounds the optical axis, and the reverse inclined structure includes at least two annular concave structures. The at least two annular concave structures are arranged in order from the object-side opening to an image side, wherein a sectional surface of each of the annular concave structures passing through the optical axis includes a valley point and two concave ends, the two concave ends are respectively disposed on an object side and an image side of the valley point, and the valley point is located on a position farthest from the optical axis on each of the annular concave structures. When a distance between each of the valley points and the concave end disposed on the image side thereof along the optical axis is a1, and a distance between the two concave ends of each of the annular concave structures along the optical axis is a2, following condition is satisfied: 0.05<a1/a2<0.90.

According to another aspect of the present disclosure, an electronic device includes the camera module according to the aforementioned aspect and an image sensor disposed on an image surface of the camera module.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional schematic view of a camera module according to the 1st embodiment of the present disclosure.

FIG. 1B is an exploded view of the camera module according to the 1st embodiment of FIG. 1A.

FIG. 1C is a schematic view of a unitary element, an optical image lens assembly and a driving member according to the 1st embodiment of FIG. 1A.

FIG. 1D is an enlarged schematic view of a reverse inclined structure according to the 1st embodiment of FIG. 1A.

FIG. 1E is a three-dimensional schematic view of the reverse inclined structure and a light blocking sheet according to the 1st embodiment of FIG. 1A.

FIG. 1F is a schematic view showing parameters according to the 1st embodiment of FIG. 1A.

FIG. 2A is a three-dimensional schematic view of a camera module according to the 2nd embodiment of the present disclosure.

FIG. 2B is an exploded view of the camera module according to the 2nd embodiment of FIG. 2A.

FIG. 2C is a schematic view of a unitary element, an optical image lens assembly and a driving member according to the 2nd embodiment of FIG. 2A.

FIG. 2D is an enlarged schematic view of a reverse inclined structure according to the 2nd embodiment of FIG. 2A.

FIG. 2E is a three-dimensional schematic view of the reverse inclined structure and a light blocking sheet according to the 2nd embodiment of FIG. 2A.

FIG. 2F is a schematic view showing parameters according to the 2nd embodiment of FIG. 2A.

FIG. 3A is a schematic view of a unitary element and an optical image lens assembly of a camera module according to the 3rd embodiment of the present disclosure.

FIG. 3B is an enlarged schematic view of a reverse inclined structure according to the 3rd embodiment of FIG. 3A.

FIG. 4A is a schematic view of a unitary element and an optical image lens assembly of a camera module according to the 4th embodiment of the present disclosure.

FIG. 4B is an enlarged schematic view of a reverse inclined structure according to the 4th embodiment of FIG. 4A.

FIG. 5A is a schematic view of a unitary element and an optical image lens assembly of a camera module according to the 5th embodiment of the present disclosure.

FIG. 5B is an enlarged schematic view of a reverse inclined structure according to according to the 5th embodiment of FIG. 5A.

FIG. 6A is a three-dimensional schematic view of a camera module according to the 6th embodiment of the present disclosure.

FIG. 6B is an exploded view of the camera module according to the 6th embodiment of FIG. 6A.

FIG. 6C is a schematic view of a unitary element, an optical image lens assembly and a driving member according to the 6th embodiment of FIG. 6A.

FIG. 6D is an enlarged schematic view of a reverse inclined structure according to the 6th embodiment of FIG. 6A.

FIG. 6E is a schematic view showing parameters according to the 6th embodiment of FIG. 6A.

FIG. 7A is a schematic view of an electronic device according to the 7th embodiment of the present disclosure.

FIG. 7B is a block diagram of the electronic device according to the 7th embodiment of FIG. 7A.

FIG. 7C is a schematic view of a selfies scene according to the 7th embodiment of FIG. 7A.

FIG. 7D is a schematic view of an image according to the 7th embodiment of FIG. 7A.

### DETAILED DESCRIPTION

The present disclosure provides a camera module including a unitary element, an optical image lens assembly, a fixed member and a driving member. The unitary element is integrally formed by a lens carrier and a lens barrel and forms a containing space. The unitary element has an object-side opening, and the object-side opening is a smallest opening of the unitary element. The optical image lens assembly is disposed in the containing space and has an optical axis. The fixed member is for accommodating the unitary element, wherein the fixed member includes a base and a cover. The cover has a through hole and is connected with the base. The driving member is for driving the unitary element to move relative to the fixed member, wherein the driving member includes at least one magnet and at least one coil, and one of the at least one magnet and the at least one coil is disposed on the fixed member and is corresponding to another one. The unitary element includes a reverse inclined structure, the reverse inclined structure is located on an image side of the object-side opening and surrounds the optical axis, and the reverse inclined structure includes at least two annular concave structures arranged in order from the object-side opening to an image side, wherein a sectional surface of each of the annular concave structures passing through the optical axis includes a valley point and two concave ends. The two concave ends are respectively disposed on an image side and an object side of the valley point, and the valley point is located on a position farthest from the optical axis on each of the annular concave structures. The unitary element is made by a non-traditional injection molding drafting method so as to achieve a more three-dimensional structure thereof. Furthermore, the stray light can be prevented effectively by the reverse inclined structure, and a clear image can be obtained along with the driving member in different situations. Furthermore, the unitary element and the fixed member can be connected with each other by a connecting member, and the connecting member can be a spring leaf, a suspension wire, a sphere member, but the present disclosure is not limited thereto.

The object-side opening is connected with one of the annular concave structures disposed closest to an object side, and two of the annular concave structures adjacent to each other are connected therewith. Therefore, it is more favorable for preventing the generation of stray light.

When a diameter of the object-side opening is ψ, and a total length of the unitary element along the optical axis is Z, the following condition is satisfied: 0.30<ψ/Z<0.80. Therefore, the image quality of the unitary element can be maintained in a more proper ratio range. Furthermore, the following condition can be satisfied: 0.35<ψ/Z<0.70. Therefore, it is favorable for maintaining the molding quality and good size accuracy of the unitary element.

When the diameter of the object-side opening is ψ, a diameter of the valley point of one of the at least two annular concave structures disposed closet to an object side is ψDo, and a diameter of the valley point of one of the at least two annular concave structures disposed closet to the image side is ψDi, the following condition is satisfied: 0.0%<(ψDi−ψDo)/ψ×100%<30%. Therefore, it is favorable for reducing the reflection of the non-imaging light with large angle. Furthermore, the following condition can be satisfied: 1.0%<(ψDi−ψDo)/ψ×100%<25%. Therefore, it is favorable for reducing the entry of the non-imaging light with large angle more effectively. Furthermore, the following condition can be satisfied: 2.0%<(ψDi−ψDo)/ψ×100%<20%. Therefore, it is favorable for arranging a range that the entry of the non-imaging light with large angle can be effectively reduced.

When a distance between each of the valley points and the concave end disposed on the image side thereof along the optical axis is a1, and a distance between the two concave ends of each of the valley points along the optical axis is a2, the following condition is satisfied: 0.05<a1/a2<0.90. Therefore, it is favorable for improving the success probability of the injection molding process of the annular concave structures. Furthermore, the following condition can be satisfied: 0.10<a1/a2<0.70. Therefore, it is favorable for arranging a range that the success probability of the injection molding process of the annular concave structures can be more improved, and it is also favorable for enhancing the efficiency to eliminate the stray light.

The reverse inclined structure can be integrally formed on unitary element. Therefore, it is favorable for enhancing the production efficiency by the elastic drafting producing method.

The driving member can drive the unitary element to move relative to the fixed member in a direction substantially parallel to the optical axis. Therefore, it is favorable for providing an autofocus function of the camera module. Furthermore, the camera module can further include another driving member, and another driving member can drive the unitary element to move relative to the fixed member in a direction substantially perpendicular to the optical axis. Therefore, it is favorable for providing an image stabilization function of the camera module. It must be noted that the term “substantially” described in the present paragraph refers to that when the unitary element is moving relative to the fixed member, the unitary element will move in a direction which is not complete perpendicular or parallel to the optical axis because of the environmental factors, but it can be substantially regarded as that overall of the unitary element is moving along the direction parallel or perpendicular to the optical axis without affecting the image quality of the camera module.

The unitary element can further include an inlaying structure, and the camera module can further include at least one sensing magnet and at least one position sensing component. The sensing magnet is coupled with the inlaying structure of the unitary element. The position sensing component corresponds to the sensing magnet, and the position sensing component is for detecting an amount of movement of the unitary element relative to the fixed member. Therefore, it is favorable for providing a miniaturized camera module with a feedback control function. It must be noted that during the injection molding process of the unitary element, the inlaying structure and the reverse inclined structure can be molded in the same time so as to achieve the effects of relative position signal feedback and the stray light elimination simultaneously.

In the present disclosure, the unitary element is integrally formed by the injection molding method, so the screw structure disposed between the lens carrier and the lens barrel in the conventional technical can be omitted. Therefore, not only it is favorable for reducing the overall size of the camera module, but also the space used to arrange the screw structure originally can be further used to arrange the sensing magnet. Accordingly, the overall space within the camera module can be used more effectively, and the position sensing component can be arranged in space of the base corresponds to the sensing magnet so as to achieve the driving function with close-looped feedback.

The object-side opening can be an aperture stop of the camera module. Therefore, it is favorable for controlling the amount of incident light of the camera module by the object-side opening of the unitary element.

The camera module can further include a transparent plate disposed on an object side of the unitary element, wherein the object-side opening of the unitary element is disposed closer to the transparent plate than the through hole of the cover. Therefore, it is favorable for applying to the miniaturized camera module and the under-screen camera module of the compact electronic device. Furthermore, the transparent plate can be a glass baseplate, a display panel or a protection board, and the present disclosure is not limited thereto.

A part of the unitary element passes through and is protruded from the through hole, and the part of the unitary element includes at least one reduction structure. Therefore, by the arrangement of the trimming structure on the unitary element, it is favorable for maintaining the elasticity of the unitary element and enhancing the demolding yield of products, and the miniaturized design thereof can be achieved in the same time.

The camera module can further include a light blocking sheet, and the reverse inclined structure is disposed between the light blocking sheet and the object-side opening. When a distance between the light blocking sheet and the object-side opening along the optical axis is L, the following condition can be satisfied: 0.15 mm<L<1.4 mm. Therefore, it is favorable for achieving the miniaturization of the camera module by the forward design of the aperture stop.

The light blocking sheet includes a central opening. When a diameter of the central opening of the light blocking sheet is ψs, and the diameter of the object-side opening is ψ, the following condition can be satisfied: 0.9<ψs/ψ<1.1. Therefore, it is favorable for eliminating the stray light effectively under the premise of good resolution quality and optical specification.

The central opening of the light blocking sheet can be an aperture stop of the camera module. Therefore, it is favorable for controlling the amount of incident light of the camera module by the central opening of the light blocking sheet.

The reverse inclined structure is gradually away from the optical axis from the object side to the image side substantially. Therefore, it is favorable for providing the drafting angle required for demolding.

When a number of the at least two annular concave structures is N, the following condition can be satisfied: 2≤N≤15. Therefore, a better number range on the molding quality and the anti-stray light efficiency can be obtained.

In the two concave ends, the concave end disposed close to the image side of the valley point is away from the optical axis than the concave end disposed close to the object side thereof. Therefore, it is favorable for reducing the probability of the generation of residues during the demolding process.

In the one of the at least two annular concave structures disposed closest to the object side, when a distance between the valley point and the optical axis is D, a distance between the concave end disposed close to the image side and the optical axis is d, and an elastic drafting ratio is defined as EDR, the following condition is satisfied: 0.0%<EDR<6.0%, wherein EDR=[(D−d)/D]×100%. Therefore, a proper range of the elastic drafting ratio can be maintained, so that the function of the elastic drafting structure can be played more ideally.

Each of the aforementioned features of the camera module of the present disclosure can be utilized in numerous combinations, so as to achieve the corresponding functionality.

The present disclosure further provides an electronic device including the aforementioned camera module and an image sensor, and the image sensor is disposed on an image surface of the camera module. Therefore, it is favorable for providing an electronic device which is miniaturized and has better image quality.

### 1st Embodiment

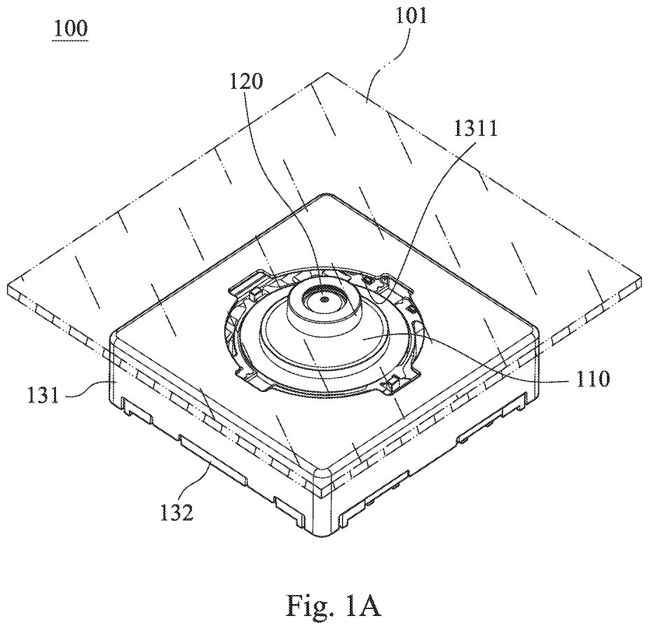

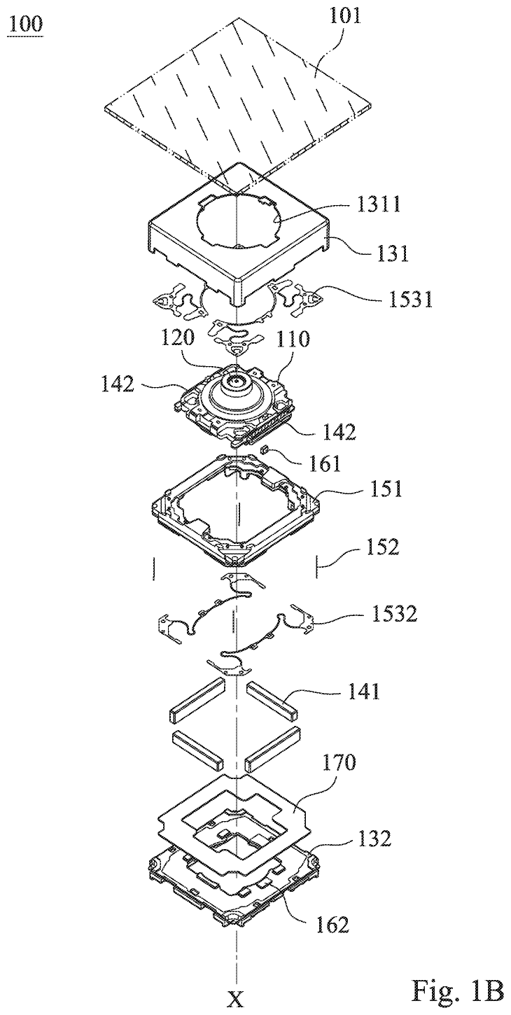

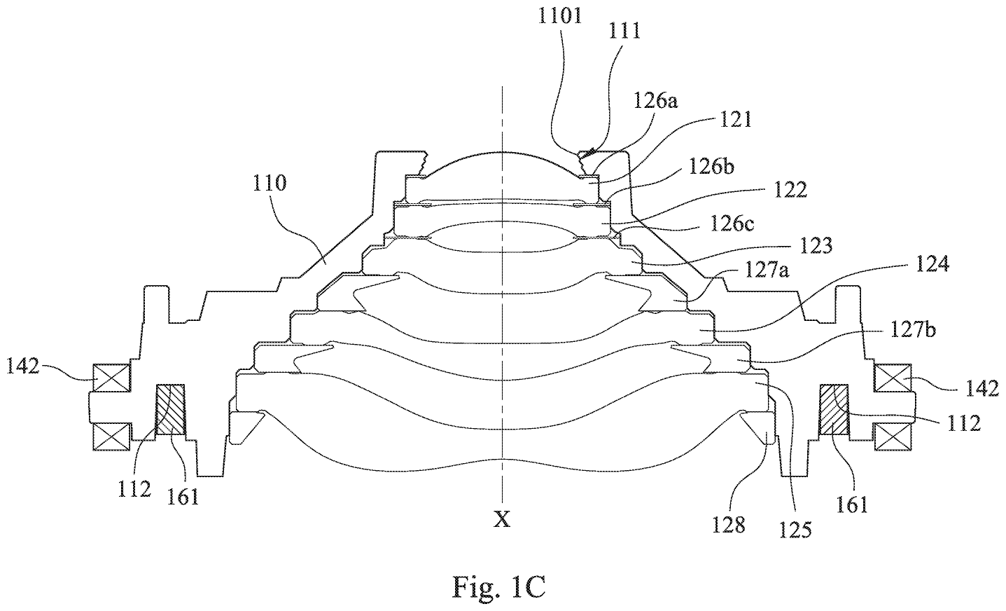

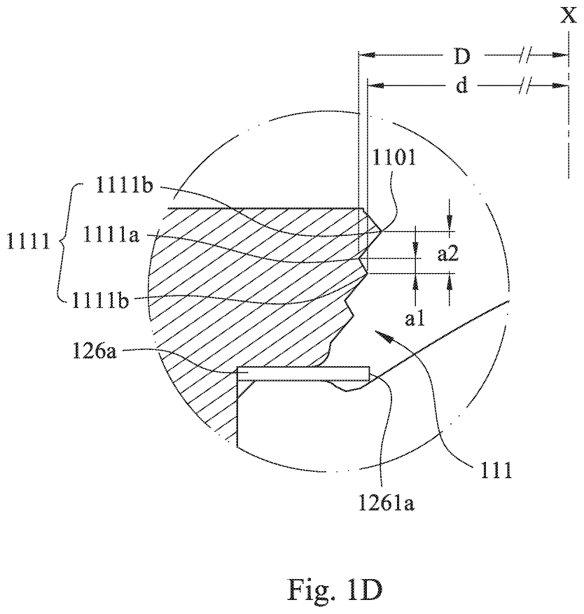

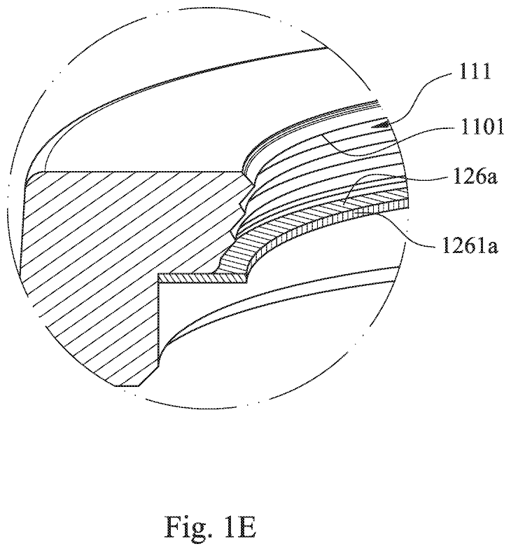

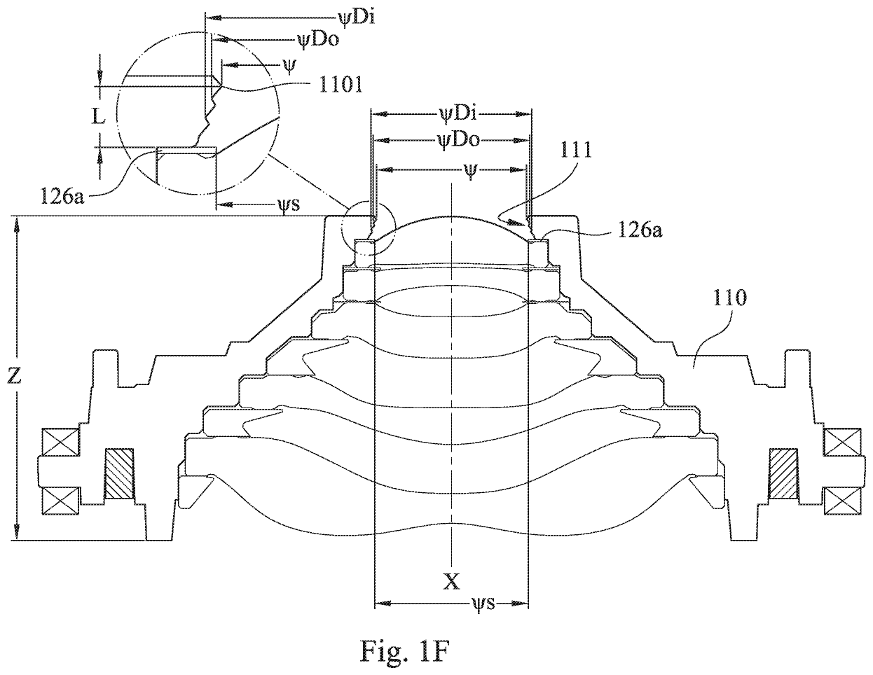

FIG. 1A is a three-dimensional schematic view of a camera module 100 according to the 1st embodiment of the present disclosure. FIG. 1B is an exploded view of the camera module 100 according to the 1st embodiment of FIG. 1A. As shown in FIG. 1A and FIG. 1B, the camera module 100 includes a unitary element 110, an optical image lens assembly 120, a fixed member (reference number is omitted) and a driving member (reference number is omitted). The fixed member includes a base 132 and a cover 131, and the cover 131 has a through hole 1311 and is connected with the base 132. The connection of the base 132 and the cover 131 forms a space for accommodating the unitary element 110, the optical image lens assembly 120 and the driving member of the camera module 100.

FIG. 10 is a schematic view of the unitary element 110, the optical image lens assembly 120 and the driving member according to the 1st embodiment of FIG. 1A. As shown in FIG. 10, the unitary element 110 is integrally formed by a lens carrier (reference number is omitted) and a lens barrel (reference number is omitted) and forms a containing space. The unitary element 110 has an object-side opening 1101, and the object-side opening 1101 is the smallest opening of the unitary element 110. Furthermore, in the 1st embodiment, the object-side opening 1101 is an aperture stop of the camera module 100. The optical image lens assembly 120 is disposed in the containing space and has an optical axis X. The fixed member is for accommodating the unitary element 110. The driving member is for driving the unitary element 110 to move relative to the fixed member so as to provide an autofocus function and an image stabilization function of the camera module 100. The driving member includes at least one magnet 141 and at least one coil 142, and one of the magnet 141 and the coil 142 is disposed on the fixed member and is corresponding to another one. In detail, in the 1st embodiment, a number of the magnet 141 is four, a number of the coil 142 is two, the magnets 141 are disposed in the cover 131 of the fixed member, the two coils 142 are respectively disposed on two opposite sides of the unitary element 110, and the magnets 141 and the coils 142 are corresponding to each other. Furthermore, the camera module 100 can further include a supporting frame 151, a plurality of suspension wires 152, a spring leaf 1531 and a spring leaf 1532. The supporting frame 151 is disposed in the cover 131, and the supporting frame 151 surrounds the unitary element 110 so that the magnet 141 can be disposed thereon stably. The spring leaf 1531 is disposed on one side of the supporting frame 151 facing to the cover 131, and the spring leaf 1532 is disposed on one side of the supporting frame 151 facing to the base 132. A number of the suspension wires 152 are four, wherein one end of each of the suspension wires 152 is connected with the spring leaf 1531, and another end of each of the suspension wires 152 is connected with the base 132. Therefore, it is favorable for driving the unitary element 110 to move relative to the fixed member more stably by the driving member. Furthermore, in the camera module of the present disclosure, the numbers of the magnet 141, the coil 142 and the suspension wires 152 are not limited by the disclosure of the 1st embodiment.

As shown in FIG. 1C, the unitary element 110 includes a reverse inclined structure 111, and the reverse inclined structure 111 is located on an image side of the object-side opening 1101 and surrounds the optical axis X. The reverse inclined structure 111 can be integrally formed on the unitary element 110. Please refer to FIG. 1D simultaneously, wherein FIG. 1D is an enlarged schematic view of the reverse inclined structure 111 according to the 1st embodiment of FIG. 1A. As shown in FIG. 1D, the reverse inclined structure 111 includes at least two annular concave structures 1111. In detail, in the 1st embodiment, when a number of the annular concave structures 1111 is N, N=2, but the present disclosure is not limited thereto. The annular concave structures 1111 are arranged in order from the object-side opening 1101 to an image side, wherein a sectional surface of each of the annular concave structures 1111 passing through the optical axis X includes a valley point 1111a and two concave ends 1111b, the two concave ends 1111b are respectively disposed on an object side and an image side of the valley point 1111a, and the valley point 1111a is located on a position farthest from the optical axis X on each of the annular concave structures 1111. In the 1st embodiment, the object-side opening 1101 is connected with one of the annular concave structures 1111 disposed closest to an object side, and two of the annular concave structure 1111 adjacent to each other are connected therewith.

Furthermore, the reverse inclined structure 111 is gradually away from the optical axis X from the object side to the image side substantially. In the two concave ends 1111b of each of the annular concave structures 1111, the concave end disposed close to the image side of the valley point 1111a is away from the optical axis X than the concave end concave end 1111b disposed close to the object side thereof.

As shown in FIG. 1C, the optical image lens assembly 120 of the camera module 100 can include, in order from the object side to the image side, a light blocking sheet 126a, a first lens element 121, a light blocking sheet 126b, a second lens element 122, a light blocking sheet 126c, a third lens element 123, a spacer 127a, a fourth lens element 124, a spacer 127b, a fifth lens element 125 and a retainer 128, but the present disclosure is not limited thereto.

FIG. 1E is a three-dimensional schematic view of the reverse inclined structure 111 and the light blocking sheet 126a according to the 1st embodiment of FIG. 1A. As shown in FIG. 1E, the reverse inclined structure 111 can be disposed between the light blocking sheet 126a and the object-side opening 1101. The light blocking sheet 126a includes a central opening 1261a.

As shown in FIG. 1A and FIG. 1B the camera module 100 can further include a transparent plate 101, and the transparent plate 101 disposed on an object side of the unitary element 110, wherein the object-side opening 1101 of the unitary element 110 is disposed closer to the transparent plate 101 than the through hole 1311 of the cover 131.

Furthermore, as shown in FIG. 1B and FIG. 10, the unitary element 110 can further include an inlaying structure 112, and the camera module 100 can further include at least one sensing magnet 161 and at least one position sensing component 162. The sensing magnet 161 is coupled with the inlaying structure 112 of the unitary element 110, and the position sensing component 162 corresponds to the sensing magnet 161 and is for detecting an amount of movement of the unitary element 110 relative to the fixed member. In the 1st embodiment, the number of both of the sensing magnet 161 and the position sensing component 162 are two, but the present disclosure is not limited thereto.

As shown in FIG. 1B, the coils 142 and the magnets 141 of the driving member are configured to drive the unitary element 110 to move relative to the fixed member in a direction substantially parallel to the optical axis X, and the camera module 100 can further include another driving member (not shown). In detail, the camera module 100 can further include a circuit board 170 including at least one image stabilization coil (not shown), and the another driving member of the 1st embodiment of the present disclosure can be the aforementioned image stabilization coil, but the present disclosure is not limited thereto. The driving member (that is, the image stabilization coil) of the circuit board 170 can drive the unitary element 110 to move relative to the fixed member in a direction substantially perpendicular to optical axis X.

FIG. 1F is a schematic view showing parameters according to the 1st embodiment of FIG. 1A. As shown in FIG. 1D and FIG. 1F, a diameter of the object-side opening 1101 is ψ, a total length of the unitary element 110 along the optical axis X is Z, a diameter of the valley point 1111a of one of the at least two annular concave structures 1111 disposed closest to the object side is ψDo, a diameter of the valley point 1111a of one of the at least two annular concave structures 1111 disposed closest to the image side is ψDi, a distance between the light blocking sheet 126a and the object-side opening 1101 along the optical axis X is L, a diameter of the central opening 1261a of the light blocking sheet 126a (reference number is shown on FIG. 1E) is ψs, a distance between each of the valley points 1111a and the concave end 1111b disposed on the image side thereof along the optical axis X is a1, and a distance between the two concave ends 1111b of each of the annular concave structures along the optical axis X is a2. Furthermore, in the one of the at least two annular concave structures 1111 disposed closest to the object side, a distance between the valley point 1111a and the optical axis X is D, a distance between the concave end 1111b disposed close to the image side and the optical axis X is d, an elastic drafting ratio is defined as EDR, and EDR=[(D−d)/D]×100%. The aforementioned parameters can satisfy the following conditions listed in Table 1.

TABLE 1
1st Embodiment

| | | | |
|---|---|---|---|
| ψ (mm) | 1.66 | L (mm) | 0.225 |
| Z (mm) | 3.6 | a1 (mm) | 0.025 |
| ψ/Z | 0.461 | a2 (mm) | 0.07 |
| ψDo | 1.736 | a1/a2 | 0.357 |
| ψDi | 1.782 | D (mm) | 0.868 |
| (ψDi − ψDo)/ | 2.771 | d (mm) | 0.853 |
| ψ × 100% (%) | | | |
| ψs (mm) | 1.7 | EDR (%) | 1.7 |
| ψs/ψ | 1.024 | | |

### 2nd Embodiment

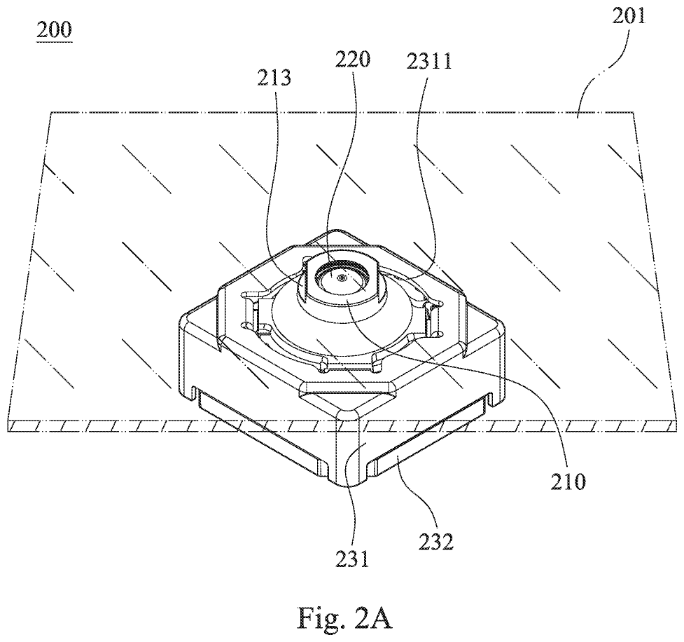

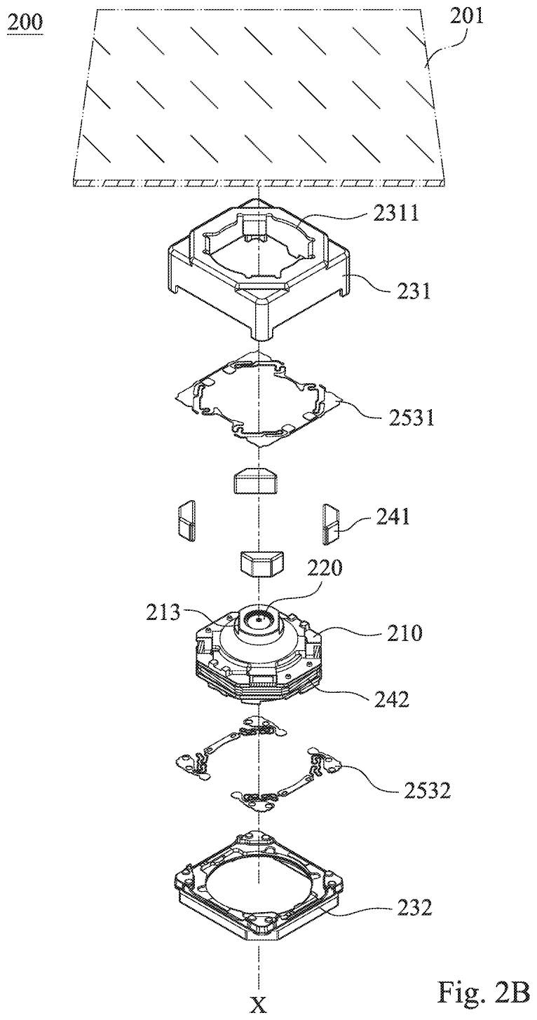

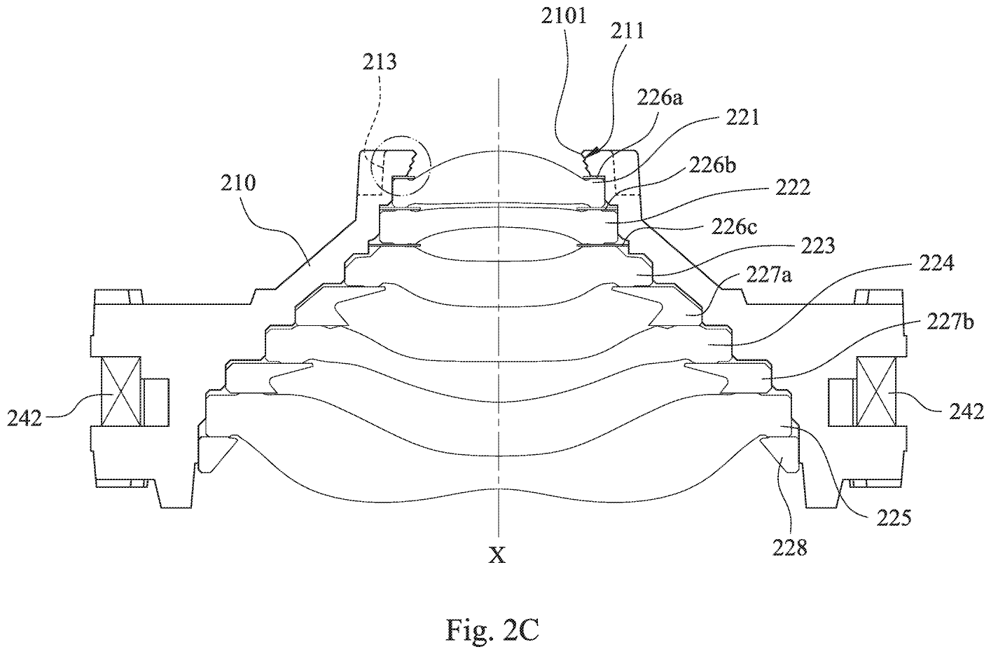

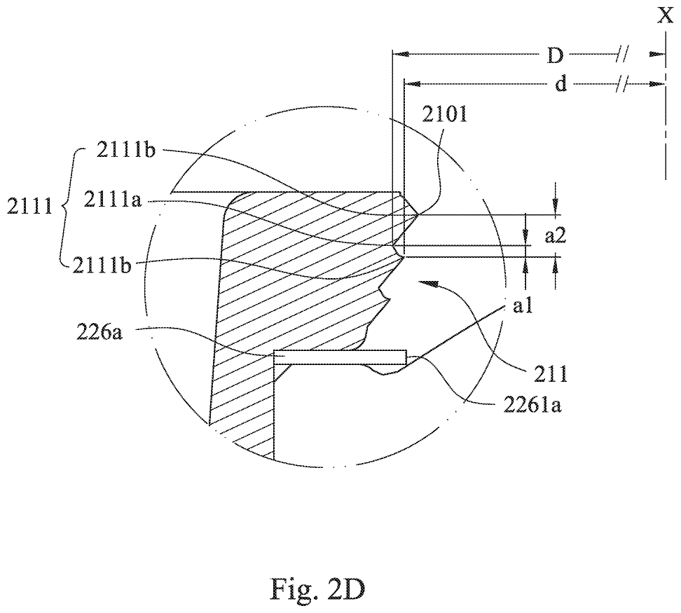

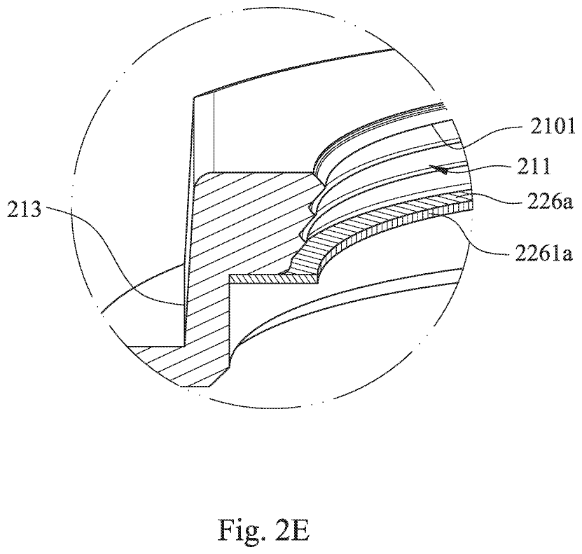

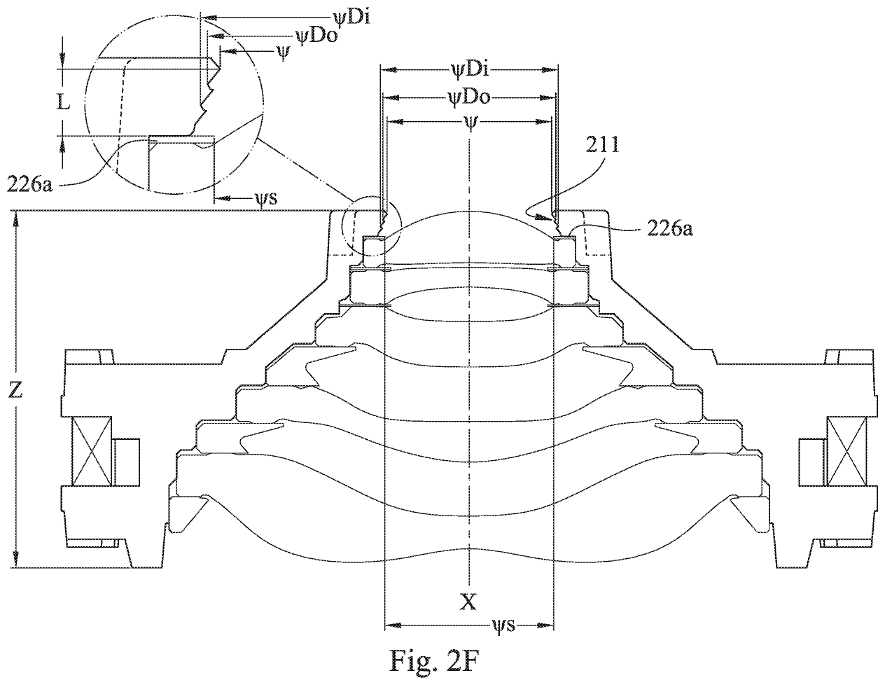

FIG. 2A is a three-dimensional schematic view of a camera module 200 according to the 2nd embodiment of the present disclosure. FIG. 2B is an exploded view of the camera module 200 according to the 2nd embodiment of FIG. 2A. As shown in FIG. 2A and FIG. 2B, the camera module 200 includes a unitary element 210, an optical image lens assembly 220, a fixed member (reference number is omitted) and a driving member (reference number is omitted). The fixed member includes a base 232 and a cover 231, and the cover 231 has a through hole 2311 and is connected with the base 232. The connection of the base 232 and the cover 231 forms a space for accommodating the unitary element 210, the optical image lens assembly 220 and the driving member camera module 200.

FIG. 2C is a schematic view of the unitary element, the optical image lens assembly and the driving member according to the 2nd embodiment of FIG. 2A. As shown in FIG. 2C, the unitary element 210 is integrally formed by a lens carrier (reference number is omitted) and a lens barrel (reference number is omitted) and forms a containing space. The unitary element 210 has an object-side opening 2101, and the object-side opening 2101 is the smallest opening of the unitary element 210. Furthermore, in the 2nd embodiment, the object-side opening 2101 is an aperture stop of the camera module 200. The optical image lens assembly 220 is disposed in the containing space and has an optical axis X. The fixed member is for accommodating the unitary element 210. The driving member is for driving the unitary element 210 to move relative to the fixed member so as to provide an autofocus function of the camera module 200. The driving member includes at least one magnet 241 and at least one coil 242, and one of the magnet 241 and the coil 242 is disposed on the fixed member and is corresponding to another one. In detail, in the 2nd embodiment, a number of the magnet 241 is four, a number of the coil 242 is one, the magnets 241 are disposed in the cover 231 of the fixed member, the coil 242 is disposed on an outer side of the unitary element 210, and the magnet 241 and the coil 242 are corresponding to each other. The coil 242 and the magnet 241 of the driving member are configured to drive the unitary element 210 to move relative to the fixed member in a direction substantially parallel to the optical axis X. Furthermore, the camera module 200 can further include a spring leaf 2531 and a spring leaf 2532. The spring leaf 2531 and the spring leaf 2532 are disposed on the two side of the unitary element 210, respectively. Therefore, it is favorable for driving the unitary element 210 to move relative to the fixed member more stably by the driving member.

As shown in FIG. 2C, the unitary element 210 includes a reverse inclined structure 211, and the reverse inclined structure 211 is located on an image side of the object-side opening 2101 and surrounds the optical axis X. The reverse inclined structure 211 can be integrally formed on the unitary element 210. Please refer to FIG. 2D simultaneously, wherein FIG. 2D is an enlarged schematic view of the reverse inclined structure 211 according to the 2nd embodiment of FIG. 2A. As shown in FIG. 2D, the reverse inclined structure 211 includes at least two annular concave structures 2111. In detail, in the 2nd embodiment, when a number of the annular concave structures 2111 is N, N=2, but the present disclosure is not limited thereto. The annular concave structures 2111 are arranged in order from the object-side opening 2101 to an image side, wherein a sectional surface of each of the annular concave structures 2111 passing through the optical axis X includes a valley point 2111a and two concave ends 2111b, the two concave ends 2111b are respectively disposed on an object side and an image side of the valley point 2111a, and the valley point 2111a is located on a position farthest from the optical axis X on each of the annular concave structures 2111. In the 2nd embodiment, the object-side opening 2101 is connected with one of the annular concave structures 2111 disposed closest to an object side, and two of the annular concave structures 2111 adjacent to each other are connected therewith.

Furthermore, the reverse inclined structure 211 is gradually away from the optical axis X from the object side to the image side substantially. In the two concave ends 2111b of each of the annular concave structures 2111, the concave end disposed close to the image side of the valley point 2111a is away from the optical axis X than the concave end 2111b disposed close to the object side thereof.

As shown in FIG. 2C, the optical image lens assembly 220 of the camera module 200 can include, in order from the object side to the image side, a light blocking sheet 226a, a first lens element 221, a light blocking sheet 226b, a second lens element 222, a light blocking sheet 226c, a third lens element 223, a spacer 227a, a fourth lens element 224, a spacer 227b, a fifth lens element 225 and a retainer 228, but the present disclosure is not limited thereto.

FIG. 2E is a three-dimensional schematic view of the reverse inclined structure 211 and the light blocking sheet 226a according to the 2nd embodiment of FIG. 2A. As shown in FIG. 2E, the reverse inclined structure 211 can be disposed between the light blocking sheet 226a and the object-side opening 2101. The light blocking sheet 226a includes a central opening 2261a.

As shown in FIG. 2A and FIG. 2B, the camera module 200 can further include a transparent plate 201, and the transparent plate 201 is disposed on an object side of the unitary element 210, wherein the object-side opening 2101 of the unitary element 210 is disposed closer to the transparent plate 201 than the through hole 2311 of the cover 231.

As shown in FIG. 2A, FIG. 2C and FIG. 2E again, a part of the unitary element 210 passes through and is protruded from the through hole 2311, and the part of the unitary element 210 includes at least one reduction structure 213. In the 2nd embodiment, a number of the reduction structure 213 is two, and the two reduction structures 213 are respectively disposed on two opposite sides of the part of the unitary element 210.

FIG. 2F is a schematic view showing parameters according to the 2nd embodiment of FIG. 2A. As shown in FIG. 2D and FIG. 2F, a diameter of the object-side opening 2101 is ψ, a total length of the unitary element 210 along the optical axis X is Z, a diameter of the valley point 2111a of one of the at least two annular concave structures 2111 disposed closest to the object side is ψDo, a diameter of the valley point 2111a of one of the at least two annular concave structures 2111 disposed closest to the image side is ψDi, a distance between the light blocking sheet 226a and the object-side opening 2101 along the optical axis X is L, a diameter of the central opening 2261a of the light blocking sheet 226a (reference number is shown on FIG. 2E) is ψs, a distance between each of the valley points 2111a and the concave end 2111b disposed on the image side thereof along the optical axis X is a1, and a distance between the two concave ends 2111b of each of the annular concave structures along the optical axis X is a2. Furthermore, in the one of the at least two annular concave structures 2111 disposed closest to the object side, a distance between the valley point 2111a and the optical axis X is D, a distance between the concave end 2111b disposed close to the image side and the optical axis X is d, an elastic drafting ratio is defined as EDR, and EDR=[(D−d)/D]×100%. The aforementioned parameters can satisfy the following conditions listed in Table 2.

TABLE 2
2nd Embodiment

| | | | |
|---|---|---|---|
| ψ (mm) | 1.66 | L (mm) | 0.225 |
| Z (mm) | 3.6 | a1 (mm) | 0.019 |
| ψ/Z | 0.461 | a2 (mm) | 0.07 |
| ψDo | 1.745 | a1/a2 | 0.271 |
| ψDi | 1.792 | D (mm) | 0.873 |
| (ψDi − ψDo)/ | 2.8 | d (mm) | 0.853 |
| ψ × 100% (%) | | | |
| ψs (mm) | 1.7 | EDR (%) | 2.3 |
| ψs/ψ | 1.024 | | |

### 3rd Embodiment

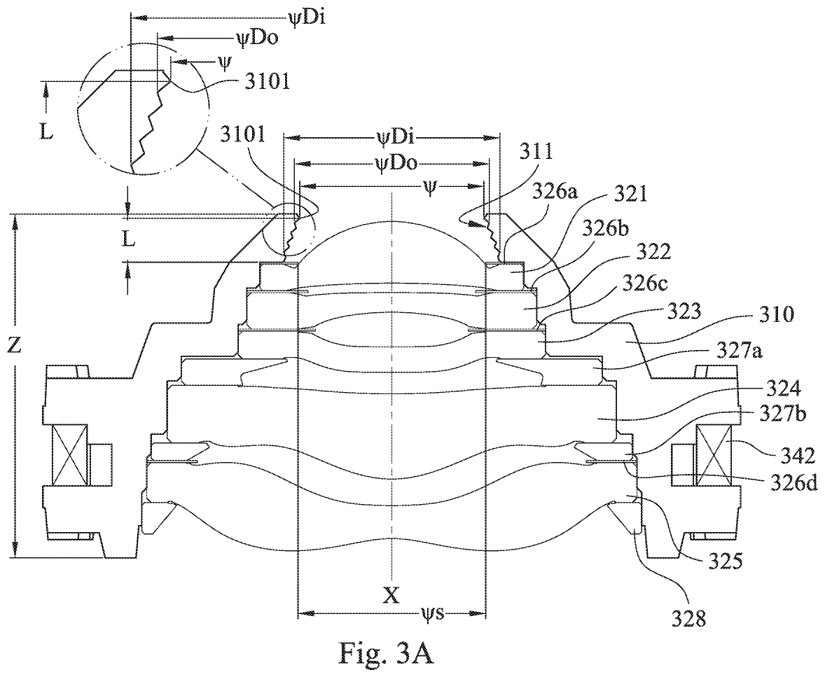

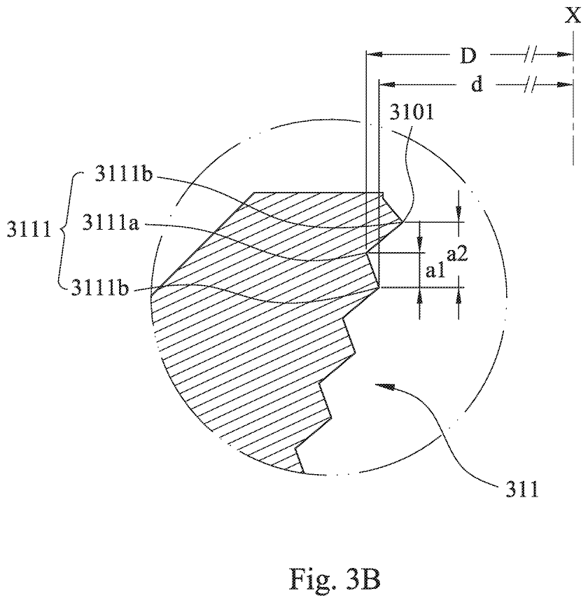

FIG. 3A is a schematic view of a unitary element 310 and an optical image lens assembly of a camera module according to the 3rd embodiment of the present disclosure. In the 3rd embodiment, the camera module (reference number is omitted) includes the unitary element 310, an optical image lens assembly (reference number is omitted), a fixed member (reference number is omitted) and a driving member (reference number is omitted), wherein the arrangement of the unitary element 310, the optical image lens assembly and other elements of the camera module is the same with that of the 2nd embodiment, so that the corresponding elements in the 3rd embodiment will use the same reference numbers of the 2nd embodiment, as shown in FIG. 2A and FIG. 2B. The fixed member includes a base 232 and a cover 231, and the cover 231 has a through hole 2311 and is connected with the base 232. The connection of the base 232 and the cover 231 forms a space for accommodating the unitary element 310, the optical image lens assembly and the driving member of the camera module.

As shown in FIG. 3A, the unitary element 310 is integrally formed by a lens carrier (reference number is omitted) and a lens barrel (reference number is omitted) and forms a containing space. The unitary element 310 has an object-side opening 3101, and the object-side opening 3101 is the smallest opening of the unitary element 310. Furthermore, in the 3rd embodiment, the object-side opening 3101 is an aperture stop of the camera module. The optical image lens assembly is disposed in the containing space and has an optical axis X. The fixed member is for accommodating the unitary element 310. The driving member is for driving the unitary element 310 to move relative to the fixed member so as to provide an autofocus function of the camera module. The driving member includes at least one magnet 241 and at least one coil 342, and one of the magnet 241 and the coil 342 is disposed on the fixed member and is corresponding to another one. In detail, in the 3rd embodiment, a number of the magnet 241 is four, a number of the coil 342 is one, the magnets 241 are disposed in the cover 231 of the fixed member, the coil 342 is disposed on an outer side of the unitary element 310, and the magnets 241 and the coil 342 are corresponding to each other. The coil 342 and the magnets 241 of the driving member are configured to drive the unitary element 310 to move relative to the fixed member in a direction substantially parallel to the optical axis X. Furthermore, the camera module can further include a spring leaf 2531 and a spring leaf 2532. The spring leaf 2531 and the spring leaf 2532 are disposed on the two side of the unitary element 310, respectively. Therefore, it is favorable for driving the unitary element 310 to move relative to the fixed member more stably by the driving member.

The unitary element 310 includes a reverse inclined structure 311, and the reverse inclined structure 311 is located on an image side of the object-side opening 3101 and surrounds the optical axis X. The reverse inclined structure 311 can be integrally formed on the unitary element 310. Please refer to FIG. 3B simultaneously, wherein FIG. 3B is an enlarged schematic view of the reverse inclined structure 311 according to the 3rd embodiment of FIG. 3A. As shown in FIG. 3B, the reverse inclined structure 311 includes at least two annular concave structures 3111. In detail, in the 3rd embodiment, when a number of the annular concave structures 3111 is N, N=4, but the present disclosure is not limited thereto. The annular concave structures 3111 are arranged in order from the object-side opening 3101 to an image side, wherein a sectional surface of each of the annular concave structures 3111 passing through the optical axis X includes a valley point 3111a and two concave ends 3111b, the two concave ends 3111b are respectively disposed on an object side and an image side of the valley point 3111a, and the valley point 3111a is located on a position farthest from the optical axis X on each of the annular concave structures 3111. In the 3rd embodiment, the object-side opening 3101 is connected with one of the annular concave structures 3111 disposed closest to an object side, and two of the annular concave structures 3111 adjacent to each other are connected therewith.

Furthermore, the reverse inclined structure 311 is gradually away from the optical axis X from the object side to the image side substantially. In the two concave ends 3111b of each of the annular concave structures 3111, the concave end 3111b disposed close to the image side of the valley point 3111a is away from the optical axis X than the concave end 3111b disposed close to the object side thereof.

As shown in FIG. 3A, the optical image lens assembly of the camera module can include, in order from the object side to the image side, a light blocking sheet 326a, a first lens element 321, a light blocking sheet 326b, a second lens element 322, a light blocking sheet 326c, a third lens element 323, a spacer 327a, a fourth lens element 324, a spacer 327b, a light blocking sheet 326e, a fifth lens element 325 and a retainer 328, but the present disclosure is not limited thereto. Furthermore, the reverse inclined structure 311 can be disposed between the light blocking sheet 326a and the object-side opening 3101. The light blocking sheet 326a includes a central opening (reference number is omitted).

As shown in FIG. 2A and FIG. 2B, in the 3rd embodiment, the camera module can further include a transparent plate 201, and the transparent plate 201 is disposed on an object side of the unitary element 310, wherein the object-side opening 3101 of the unitary element 310 is disposed closer to the transparent plate 201 than the through hole 2311 of the cover 231.

As shown in FIG. 3A and FIG. 3B, a diameter of the object-side opening 3101 is ψ, a total length of the unitary element 310 along the optical axis X is Z, a diameter of the valley point 3111a of one of the at least two annular concave structures 3111 disposed closest to the object side is ψDo, a diameter of the valley point 3111a of one of the at least two annular concave structures 3111 disposed closest to the image side is ψDi, a distance between the light blocking sheet 326a and the object-side opening 3101 along the optical axis X is L, a diameter of the central opening of the light blocking sheet 326a is ψs, a distance between each of the valley points 3111a and the concave end 3111b disposed on the image side thereof along the optical axis X is a1, and a distance between the two concave ends 3111b of each of the annular concave structures along the optical axis X is a2. Furthermore, in the one of the at least two annular concave structures 3111 disposed closest to the object side, a distance between the valley point 3111a and the optical axis X is D, a distance between the concave end 3111b disposed close to the image side and the optical axis X is d, an elastic drafting ratio is defined as EDR, and EDR=[(D−d)/D]×100%. The aforementioned parameters can satisfy the following conditions listed in Table 3.

TABLE 3
3rd Embodiment

| | | | |
|---|---|---|---|
| ψ (mm) | 2.1 | L (mm) | 0.5 |
| Z (mm) | 3.923 | a1 (mm) | 0.059 |
| ψ/Z | 0.535 | a2 (mm) | 0.11 |
| ψDo | 2.223 | a1/a2 | 0.536 |
| ψDi | 2.463 | D (mm) | 1.111 |
| (ψDi − ψDo)/ | 11.4 | d (mm) | 1.090 |
| ψ × 100% (%) | | | |
| ψs (mm) | 2.14 | EDR (%) | 1.9 |
| ψs/ψ | 1.019 | | |

### 4th Embodiment

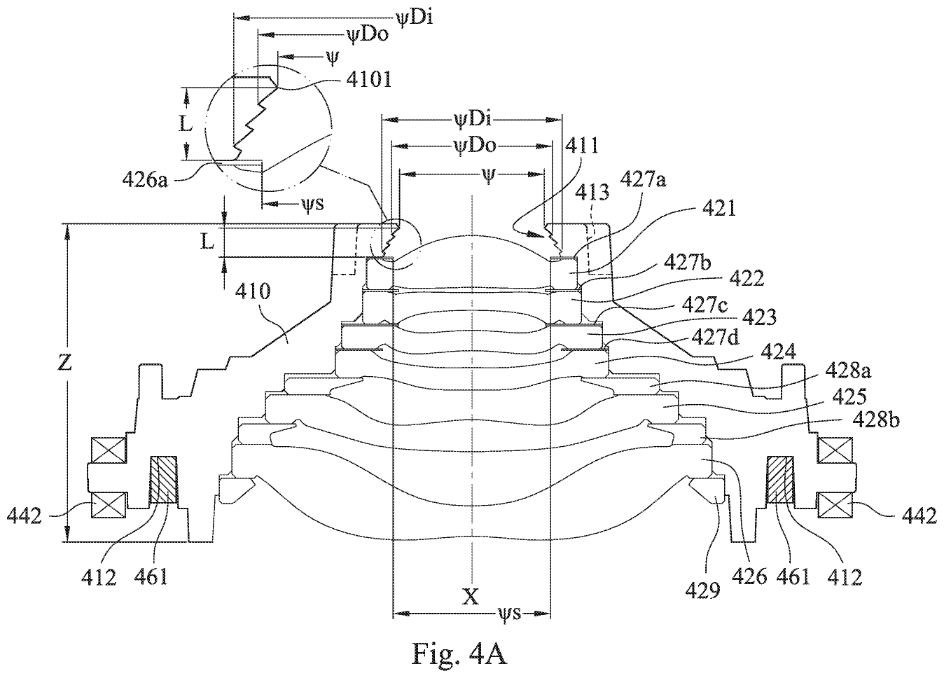

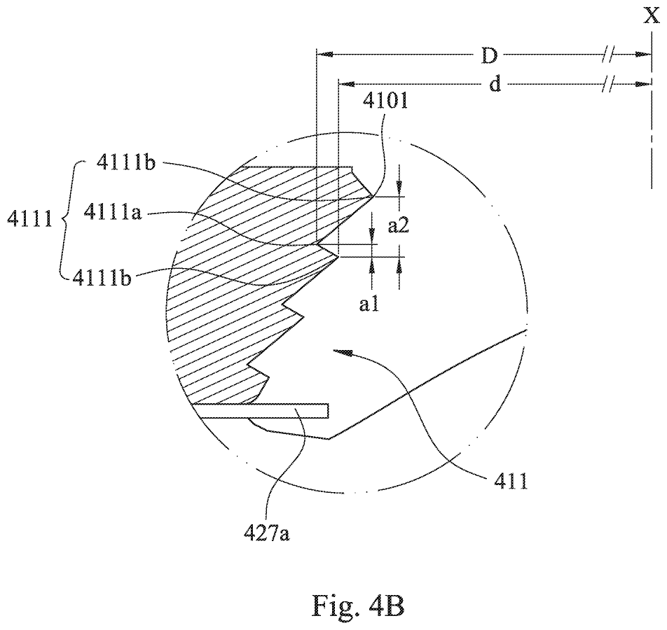

FIG. 4A is a schematic view of a unitary element 410 and an optical image lens assembly of a camera module according to the 4th embodiment of the present disclosure. In the 4th embodiment, the camera module (reference number is omitted) includes the unitary element 410, an optical image lens assembly (reference number is omitted), a fixed member (reference number is omitted) and a driving member (reference number is omitted), wherein the arrangement of the unitary element 410, the optical image lens assembly and other elements of the camera module is the same with that of the 1st embodiment, so that the corresponding elements in the 4th embodiment will use the same reference numbers of the 1st embodiment, as shown in FIG. 1A and FIG. 1B. The fixed member includes a base 132 and a cover 131, and the cover 131 has a through hole 1311 and is connected with the base 132. The connection of the base 132 and the cover 131 forms a space for accommodating the unitary element 410, the optical image lens assembly and the driving member of the camera module.

As shown in FIG. 4A, the unitary element 410 is integrally formed by a lens carrier (reference number is omitted) and a lens barrel (reference number is omitted) and forms a containing space. The unitary element 410 has an object-side opening 4101, and the object-side opening 4101 is the smallest opening of the unitary element 410. Furthermore, in the 4th embodiment, the object-side opening 4101 is an aperture stop of the camera module. The optical image lens assembly is disposed in the containing space and has an optical axis X. The fixed member is for accommodating the unitary element 410. The driving member is for driving the unitary element 410 to move relative to the fixed member so as to provide an autofocus function and an image stabilization function of the camera module. The driving member includes at least one magnet 141 and at least one coil 442, and one of the magnet 141 and the coil 442 is disposed on the fixed member and is corresponding to another one. In detail, in the 4th embodiment, a number of the magnets 141 is four, a number of the coil 442 is two, the magnets 141 are disposed in the cover 131 of the fixed member, the coils 442 are respectively disposed on two opposite sides of the unitary element 410, and the magnets 141 and the coils 442 are corresponding to each other. Furthermore, the camera module can further include a supporting frame 151, a plurality of suspension wires 152, a spring leaf 1531 and a spring leaf 1532. The supporting frame 151 is disposed in the cover 131, and the supporting frame 151 surrounds the unitary element 410 so that the magnet 141 can be disposed thereon stably. The spring leaf 1531 is disposed on one side of the supporting frame 151 facing to the cover 131, and the spring leaf 1532 is disposed on one side of the supporting frame 151 facing to the base 132. A number of the suspension wires 152 is four, wherein one end of each of the suspension wires 152 is connected with the spring leaf 1531, and another end of each of the suspension wires 152 is connected with the base 132. Therefore, it is favorable for driving the unitary element 410 to move relative to the fixed member more stably by the driving member. Furthermore, in the camera module of the present disclosure, the numbers of the magnet 141, the coil 442 and the suspension wires 152 are not limited by the disclosure of the 4th embodiment.

The unitary element 410 includes a reverse inclined structure 411, and the reverse inclined structure 411 is located on an image side of the object-side opening 4101 and surrounds the optical axis X. The reverse inclined structure 411 can be integrally formed on the unitary element 410. Please refer to FIG. 4B simultaneously, wherein FIG. 4B is an enlarged schematic view of the reverse inclined structure 411 according to the 4th embodiment of FIG. 4A. As shown in FIG. 4B, the reverse inclined structure 411 includes at least two annular concave structures 4111. In detail, in the 4th embodiment, when a number of the annular concave structures 4111 is N, N=3, but the present disclosure is not limited thereto. The annular concave structures 4111 are arranged in order from the object-side opening 4101 to an image side, wherein a sectional surface of each of the annular concave structures 4111 passing through the optical axis X includes a valley point 4111a and two concave ends 4111b, the two concave ends 4111b are respectively disposed on an object side and an image side of the valley point 4111a, and the valley point 4111a is located on a position farthest from the optical axis X on each of the annular concave structures 4111. In the 4th embodiment, the object-side opening 4101 is connected with one of the annular concave structures disposed closest to an object side, and two of the annular concave structures 4111 adjacent to each other are connected therewith.

Furthermore, the reverse inclined structure 411 is gradually away from the optical axis X from the object side to the image side substantially. In the two concave ends 4111b of each of the annular concave structures 4111, the concave end 4111b disposed close to the image side of the valley point 4111a is away from the optical axis X than the concave end 4111b disposed close to the object side thereof.

As shown in FIG. 4A, the optical image lens assembly of the camera module can include, in order from the object side to the image side, a light blocking sheet 427a, a first lens element 421, a light blocking sheet 427b, a second lens element 422, a light blocking sheet 427c, a third lens element 423, a light blocking sheet 427d, a fourth lens element 424, a spacer 428a, a fifth lens element 425, a spacer 428b, a sixth lens element 426 and a retainer 429, but the present disclosure is not limited thereto. Furthermore, the reverse inclined structure 411 can be disposed between the light blocking sheet 427a and the object-side opening 4101. The light blocking sheet 427a includes a central opening (reference number is omitted).

As shown in FIG. 1A and FIG. 1B, in the 4th embodiment, the camera module can further include a transparent plate 101, and the transparent plate 101 is disposed on an object side of the unitary element 410, wherein the object-side opening 4101 of the unitary element 410 is disposed closer to the transparent plate 101 than the through hole 1311 of the cover 131.

A part of the unitary element 410 passes through and is protruded from the through hole 1311, and the part of the unitary element 410 includes at least one reduction structure 413. In the 4th embodiment, a number of the reduction structure 413 is two, and the two reduction structures 413 are respectively disposed on two opposite sides of the part of the unitary element 410.

Furthermore, as shown in FIG. 4A and FIG. 1B, the unitary element 410 can further include an inlaying structure 412, and the camera module can further include at least one sensing magnet 461 and at least one position sensing component 162. The sensing magnet 461 is coupled with the inlaying structure 412 of the unitary element 410, and the position sensing component 162 corresponds to the sensing magnet 461 and is for detecting an amount of movement of the unitary element 410 relative to the fixed member. In the 4th embodiment, the number of both of the sensing magnet 461 and the position sensing component 162 are two, but the present disclosure is not limited thereto.

As shown in FIG. 1B, in the 4th embodiment, the coils 442 and the magnets 141 of the driving member are configured to drive the unitary element 410 to move relative to the fixed member in a direction substantially parallel to the optical axis X, and the camera module can further include another driving member (not shown). In detail, the camera module can further include a circuit board 170 including at least one image stabilization coil (not shown), and the another driving member of the 4th embodiment of the present disclosure can be the aforementioned image stabilization coil, but the present disclosure is not limited thereto. The driving member (that is, the image stabilization coil) of the circuit board 170 can drive the unitary element 410 to move relative to the fixed member in a direction substantially perpendicular to optical axis X.

As shown in FIG. 4A and FIG. 4B, a diameter of the object-side opening 4101 is ψ, a total length of the unitary element 410 along the optical axis X is Z, a diameter of the valley point 4111a of one of the at least two annular concave structures 4111 disposed closest to the object side is ψDo, a diameter of the valley point 4111a of one of the at least two annular concave structures 4111 disposed closest to the image side is ψDi, a distance between the light blocking sheet 427a and the object-side opening 4101 along the optical axis X is L, a diameter of the central opening of the light blocking sheet 427a is ψs, a distance between each of the valley points 4111a and the concave end 4111b disposed on the image side thereof along the optical axis X is a1, and a distance between the two concave ends 4111b of each of the annular concave structures along the optical axis X is a2. Furthermore, in the one of the at least two annular concave structures 4111 disposed closest to the object side, a distance between the valley point 4111a and the optical axis X is D, a distance between the concave end 4111b disposed close to the image side and the optical axis X is d, an elastic drafting ratio is defined as EDR, and EDR=[(D−d)/D]×100%. The aforementioned parameters can satisfy the following conditions listed in Table 4.

TABLE 4
4th Embodiment

| | | | |
|---|---|---|---|
| ψ (mm) | 1.72 | L (mm) | 0.345 |
| Z (mm) | 3.78 | a1 (mm) | 0.021 |
| ψ/Z | 0.455 | a2 (mm) | 0.1 |
| ψDo | 1.908 | a1/a2 | 0.21 |
| ψDi | 2.139 | D (mm) | 0.954 |
| (ψDi − ψDo)/ | 13.4 | d (mm) | 0.918 |
| ψ × 100% (%) | | | |
| ψs (mm) | 1.87 | EDR (%) | 3.8 |
| ψs/ψ | 1.087 | | |

### 5th Embodiment

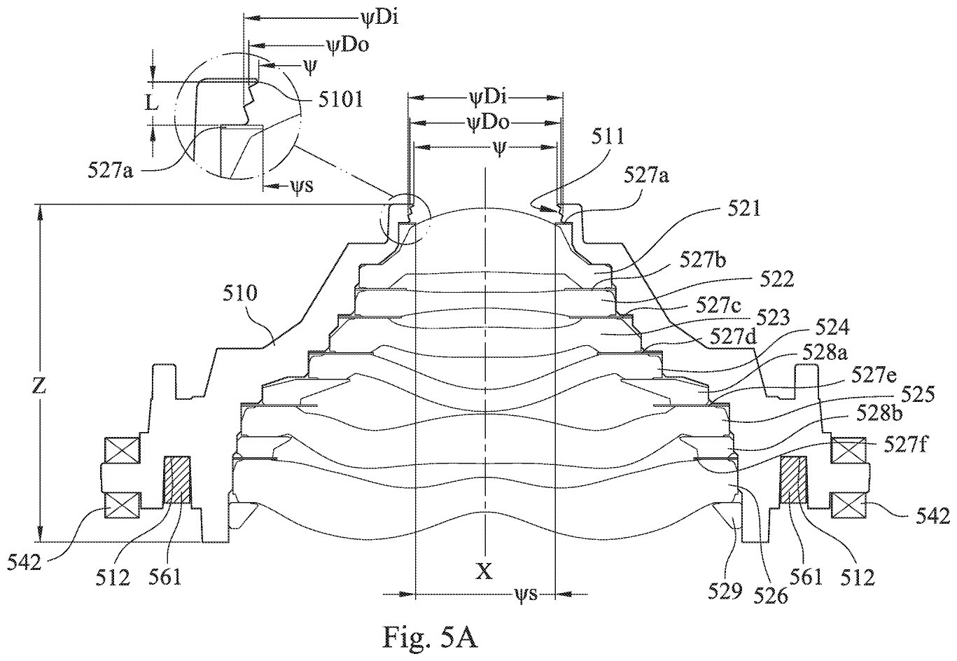

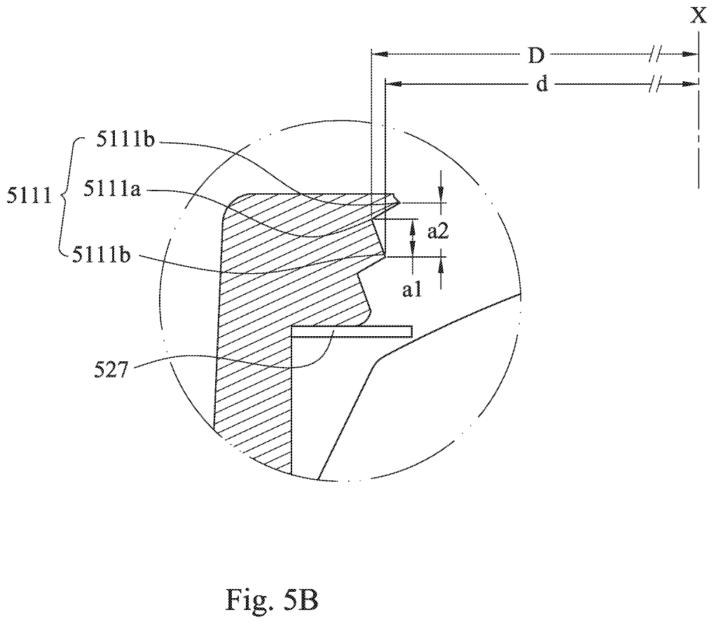

FIG. 5A is a schematic view of a unitary element 510 and an optical image lens assembly of a camera module according to the 5th embodiment of the present disclosure. In the 5th embodiment, the camera module (reference number is omitted) includes a unitary element 510, an optical image lens assembly (reference number is omitted), a fixed member (reference number is omitted) and a driving member (reference number is omitted), wherein the arrangement of the unitary element 510, the optical image lens assembly and other elements of the camera module is the same with that of the 1st embodiment, so that the corresponding elements in the 5th embodiment will use the same reference numbers of the 1st embodiment, as shown in FIG. 1A and FIG. 1B. The fixed member includes a base 132 and a cover 131, and the cover 131 has a through hole 1311 and is connected with the base 132. The connection between the base 132 and the cover 131 forms a space for accommodating the unitary element 510, the optical image lens assembly and the driving member camera module.

As shown in FIG. 5A, the unitary element 510 is integrally formed by a lens carrier (reference number is omitted) and a lens barrel (reference number is omitted) and forms a containing space. The unitary element 510 has an object-side opening 5101, and the object-side opening 5101 is the smallest opening of the unitary element 510. The optical image lens assembly is disposed in the containing space and has an optical axis X. The fixed member is for accommodating the unitary element 510. The driving member is for driving the unitary element 510 to move relative to the fixed member so as to provide an autofocus function and an image stabilization function of the camera module. The driving member includes at least one magnet 141 and at least one coil 542, and one of the magnet 141 and the coil 542 is disposed on the fixed member and is corresponding to another one. In detail, in the 5th embodiment, a number of the magnet 141 is four, a number of the coil 542 is two, the magnets 141 are disposed in the cover 131 of the fixed member, the coils 542 are respectively disposed on two opposite sides of the unitary element 510, and the magnets 141 and the coils 542 are corresponding to each other. Furthermore, the camera module can further include a supporting frame 151, a plurality of suspension wires 152, a spring leaf 1531 and a spring leaf 1532. The supporting frame 151 is disposed in the cover 131, and the supporting frame 151 surrounds the unitary element 510 so that the magnet 141 can be disposed thereon stably. The spring leaf 1531 is disposed on one side of the supporting frame 151 facing to the cover 131, and the spring leaf 1532 is disposed on one side of the supporting frame 151 facing to the base 132. A number of the suspension wires is four, wherein one end of each of the suspension wires 152 is connected with the spring leaf 1531, and another end of each of the suspension wires 152 is connected with the base 132. Therefore, it is favorable for driving the unitary element 510 to move relative to the fixed member more stably by the driving member. Furthermore, in the camera module of the present disclosure, the numbers of the magnet 141, the coil 542 and the suspension wires 152 are not limited by the disclosure of the 5th embodiment.

The unitary element 510 includes a reverse inclined structure 511, and the reverse inclined structure 511 is located on an image side of the object-side opening 5101 and surrounds the optical axis X. The reverse inclined structure 511 can be integrally formed on the unitary element 510. Please refer to FIG. 5B simultaneously, wherein FIG. 5B is an enlarged schematic view of the reverse inclined structure 511 according to according to the 5th embodiment of FIG. 5A. As shown in FIG. 5B, the reverse inclined structure 511 includes at least two annular concave structures 5111. In detail, in the 5th embodiment, when a number of the annular concave structures 5111 is N, N=2, but the present disclosure is not limited thereto. The annular concave structures 5111 are arranged in order from the object-side opening 5101 to an image side, wherein a sectional surface of each of the annular concave structures 5111 passing through the optical axis X includes a valley point 5111a and two concave ends 5111b, the two concave ends 5111b are respectively disposed on an object side and an image side of the valley point 5111a, and the valley point 5111a is located on a position farthest from the optical axis X on each of the annular concave structures 5111. In the 5th embodiment, the object-side opening 5101 is connected with one of the annular concave structures 511 disposed closest to an object side, and two of the annular concave structures 5111 adjacent to each other are connected therewith.

Furthermore, the reverse inclined structure 511 is gradually away from the optical axis X from the object side to the image side substantially. In the two concave ends 5111b of each of the annular concave structures 5111, the concave end 5111b disposed close to the image side of the valley point 5111a is away from the optical axis X than the concave end 5111b disposed close to the object side thereof.

As shown in FIG. 5A, the optical image lens assembly of the camera module can include, in order from the object side to the image side, a light blocking sheet 527a, a first lens element 521, a light blocking sheet 527b, a second lens element 522, a light blocking sheet 527c, a third lens element 523, a light blocking sheet 527d, a fourth lens element 524, a spacer 528a, a light blocking sheet 527e, a fifth lens element 525, a spacer 528b, a light blocking sheet 527f, a sixth lens element 526 and a retainer 529, but the present disclosure is not limited thereto. Furthermore, the reverse inclined structure 511 can be disposed between the light blocking sheet 527a and the object-side opening 5101. The light blocking sheet 527a includes a central opening (reference number is omitted). In the 5th embodiment, the central opening of the light blocking sheet is an aperture stop of the camera module.

As shown in FIG. 1A and FIG. 1B, in the 5th embodiment, the camera module can further include a transparent plate 101, and the transparent plate 101 is disposed on an object side of the unitary element 510, wherein the object-side opening 5101 of the unitary element 510 is disposed closer to the transparent plate 101 than the through hole 1311 of the cover 131.

Furthermore, as shown in FIG. 5A and FIG. 1B, the unitary element 510 can further include an inlaying structure 512, and the camera module can further include at least one sensing magnet 561 and at least one position sensing component 162. The sensing magnet 561 is coupled with the inlaying structure 512 of the unitary element 510, and the position sensing component 162 corresponds to the sensing magnet 561 and is for detecting an amount of movement of the unitary element 510 relative to the fixed member. In the 5th embodiment, the number of both of the sensing magnet 561 and the position sensing component 162 are two, but the present disclosure is not limited thereto.

As shown in FIG. 1B, in the 5th embodiment, the coils 542 and the magnets 141 of the driving member are configured to drive the unitary element 510 to move relative to the fixed member in a direction substantially parallel to the optical axis X, and the camera module can further include another driving member (not shown). In detail, the camera module can further include a circuit board 170 including at least one image stabilization coil (not shown), and the another driving member of the 5th embodiment of the present disclosure can be the aforementioned image stabilization coil, but the present disclosure is not limited thereto. The driving member (that is, the image stabilization coil) of the circuit board 170 can drive the unitary element 510 to move relative to the fixed member in a direction substantially perpendicular to optical axis X.

As shown in FIG. 5A and FIG. 5B, a diameter of the object-side opening 5101 is ψ, a total length of the unitary element 510 along the optical axis X is Z, a diameter of the valley point 5111a of one of the at least two annular concave structures 5111 disposed closest to the object side is ψDo, a diameter of the valley point 5111a of one of the at least two annular concave structures 5111 disposed closest to the image side is ψDi, a distance between the light blocking sheet 527a and the object-side opening 5101 along the optical axis X is L, a diameter of the central opening of the light blocking sheet 527a is ψs, a distance between each of the valley points 5111a and the concave end 5111b disposed on the image side thereof along the optical axis X is a1, and a distance between the two concave ends 5111b of each of the annular concave structures along the optical axis X is a2. Furthermore, in the one of the at least two annular concave structures 5111 disposed closest to the object side, a distance between the valley point 5111a and the optical axis X is D, a distance between the concave end 5111b disposed close to the image side and the optical axis X is d, an elastic drafting ratio is defined as EDR, and EDR=[(D−d)/D]×100%. The aforementioned parameters can satisfy the following conditions listed in Table 5.

TABLE 5
5th Embodiment

| | | | |
|---|---|---|---|
| ψ (mm) | 1.7 | L (mm) | 0.205 |
| Z (mm) | 4.015 | a1 (mm) | 0.063 |
| ψ/Z | 0.423 | a2 (mm) | 0.09 |
| ψDo | 1.794 | a1/a2 | 0.7 |
| ψDi | 1.842 | D (mm) | 0.897 |
| (ψDi − ψDo)/ | 2.8 | d (mm) | 0.874 |
| ψ × 100% (%) | | | |
| ψs (mm) | 1.66 | EDR (%) | 2.6 |
| ψs/ψ | 0.976 | | |

### 6th Embodiment

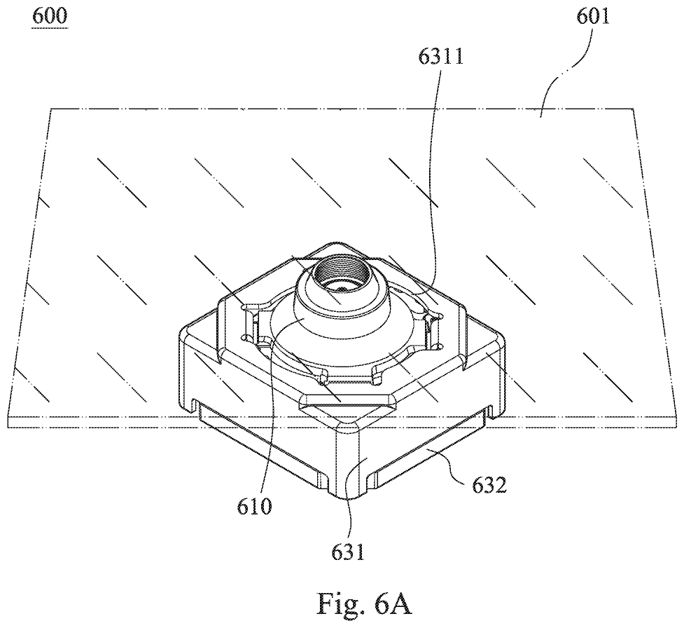

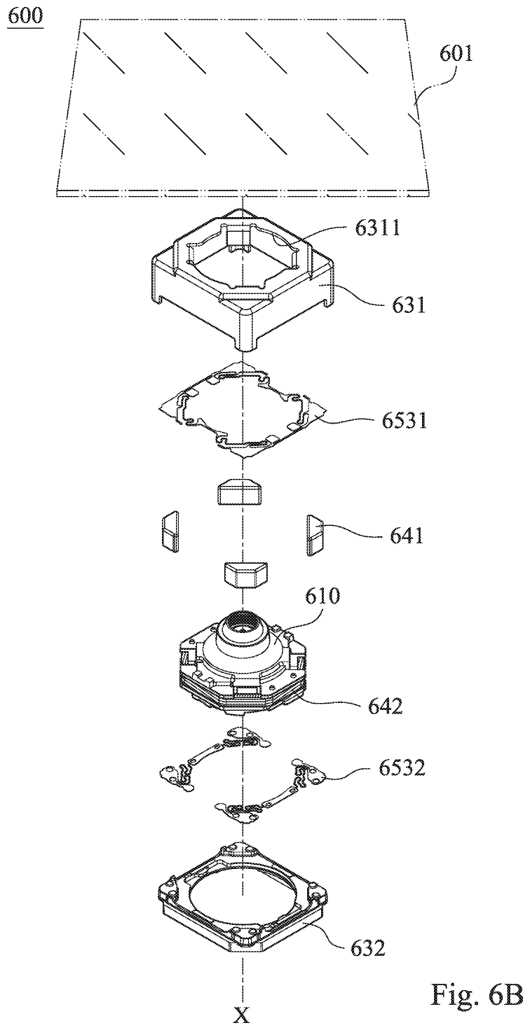

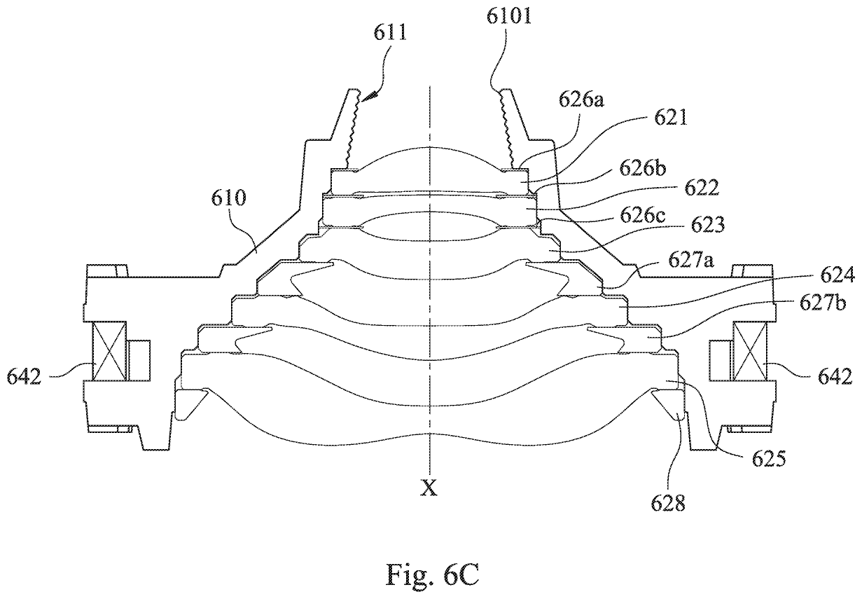

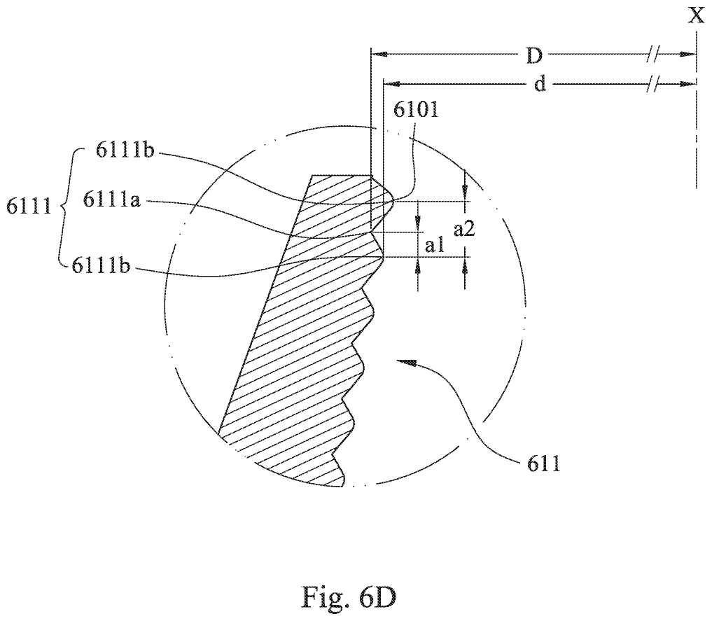

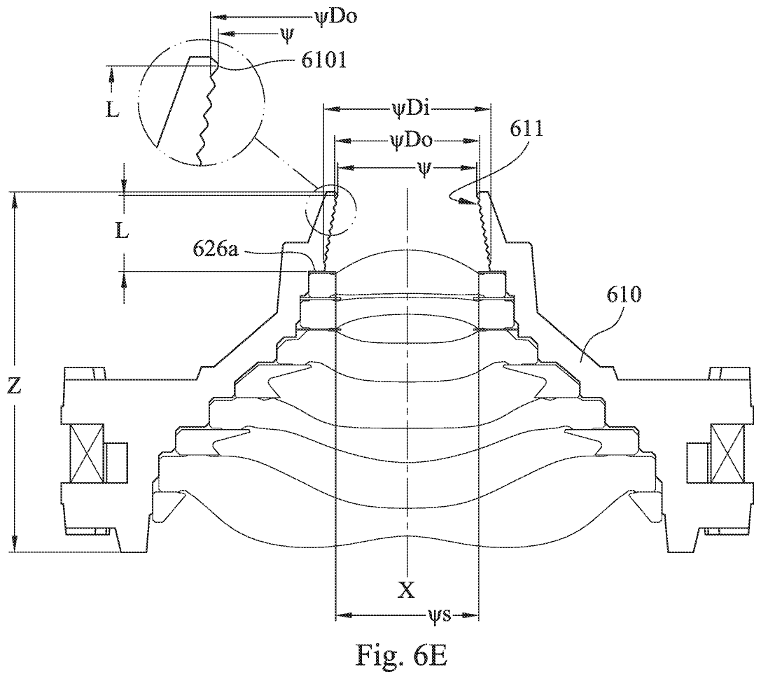

FIG. 6A is a three-dimensional schematic view of a camera module 600 according to the 6th embodiment of the present disclosure. FIG. 6B is an exploded view of the camera module 600 according to the 6th embodiment of FIG. 6A. As shown in FIG. 6A and FIG. 6B, the camera module 600 includes a unitary element 610, an optical image lens assembly (reference number is omitted), a fixed member (reference number is omitted) and a driving member (reference number is omitted). The fixed member includes a base 632 and a cover 631, and the cover 631 has a through hole 6311 and is connected with the base 632. The connection of the base 632 and the cover 631 forms a space for accommodating the unitary element 610, the optical image lens assembly and the driving member of the camera module 600.

FIG. 6C is a schematic view of the unitary element 610, the optical image lens assembly and the driving member according to the 6th embodiment of FIG. 6A. As shown in FIG. 6C, the unitary element 610 is integrally formed by a lens carrier (reference number is omitted) and a lens barrel (reference number is omitted) and forms a containing space. The unitary element 610 has an object-side opening 6101, and the object-side opening 6101 is the smallest opening of the unitary element 610. Furthermore, in the 6th embodiment, the object-side opening 6101 is an aperture stop of the camera module 600. The optical image lens assembly is disposed in the containing space and has an optical axis X. The fixed member is for accommodating the unitary element 610. The driving member is for driving the unitary element 610 to move relative to the fixed member so as to provide an autofocus function and an image stabilization function of the camera module 600. The driving member includes at least one magnet 641 and at least one coil 642, and one of the magnet 641 and the coil 642 is disposed on the fixed member and is corresponding to another one. In detail, in the 6th embodiment, a number of the magnet 641 is four, a number of the coil 642 is one, the magnets 641 are disposed in the cover 631 of the fixed member, the coil 642 is disposed on an outer side of the unitary element 610, and the magnets 641 and the coil 642 are corresponding to each other. The coil 642 and the magnets 641 of the driving member are configured to drive the unitary element 610 to move relative to the fixed member in a direction substantially parallel to the optical axis X. Furthermore, the camera module 600 can further include a spring leaf 6531 and a spring leaf 6532. The spring leaf 6531 and the spring leaf 6532 are disposed on the two side of the unitary element 610. Therefore, it is favorable for driving the unitary element 610 to move relative to the fixed member more stably by the driving member.

As shown in FIG. 6C, the unitary element 610 includes a reverse inclined structure 611, and the reverse inclined structure 611 is located on an image side of the object-side opening 6101 and surrounds the optical axis X. The reverse inclined structure 611 can be integrally formed on the unitary element 610. Please refer to FIG. 6D simultaneously, wherein FIG. 6D is an enlarged schematic view of the reverse inclined structure 611 according to the 6th embodiment of FIG. 6A. As shown in FIG. 6D, the reverse inclined structure 611 includes at least two annular concave structures 6111. In detail, in the 6th embodiment, when a number of the annular concave structures 6111 is N, N=9, but the present disclosure is not limited thereto. The annular concave structures 6111 are arranged in order from the object-side opening 6101 to an image side, wherein a sectional surface of each of the annular concave structures 6111 passing through the optical axis X includes a valley point 6111a and two concave ends 6111b, the two concave ends 6111b are respectively disposed on an object side and an image side of the valley point 6111a and the valley point 6111a is located on a position farthest from the optical axis X on each of the annular concave structures 611. In the 6th embodiment, the object-side opening 6101 is connected with one of the annular concave structures 6111 disposed closest to an object side, and two of the annular concave structures 6111 adjacent to each other are connected therewith.

Furthermore, the reverse inclined structure 611 is gradually away from the optical axis X from the object side to the image side substantially. In the two concave ends 6111b of each of the annular concave structures 6111, the concave end 6111b disposed close to the image side of the valley point 6111a is away from the optical axis X than the concave end 6111b disposed close to the object side thereof.

As shown in FIG. 6C, the optical image lens assembly of the camera module 600 can include, in order from the object side to the image side, a light blocking sheet 626a, a first lens element 621, a light blocking sheet 626b, a second lens element 622, a light blocking sheet 626c, a third lens element 623, a spacer 627a, a fourth lens element 624, a spacer 627b, a fifth lens element 625 and a retainer 628, but the present disclosure is not limited thereto.

The reverse inclined structure 611 can be disposed between the light blocking sheet 626a and the object-side opening 6101. The light blocking sheet 626a includes a central opening (reference number is omitted). In the 6th embodiment, the central opening of the light blocking sheet 626a is an aperture stop of the camera module 600.

As shown in FIG. 6A and FIG. 6B, the camera module 600 can further include a transparent plate 601, and the transparent plate 601 is disposed on an object side of the unitary element 610, wherein the object-side opening 6101 of the unitary element 610 is disposed closer to the transparent plate 601 than the through hole 6311 of the cover 631.

FIG. 6E is a schematic view showing parameters according to the 6th embodiment of FIG. 6A. As shown in FIG. 6D and FIG. 6E, a diameter of the object-side opening 6101 is ψ, a total length of the unitary element 610 along the optical axis X is Z, a diameter of the valley point 6111a of one of the at least two annular concave structures 6111 disposed closest to the object side is ψDo, a diameter of the valley point 6111a of one of the at least two annular concave structures 6111 disposed closest to the image side is ψDi, a distance between the light blocking sheet 627a and the object-side opening 6101 along the optical axis X is L, a diameter of the central opening of the light blocking sheet 627a is ψs, a distance between each of the valley points 6111a and the concave end 6111b disposed on the image side thereof along the optical axis X is a1, and a distance between the two concave ends 6111b of each of the annular concave structures along the optical axis X is a2. Furthermore, in the one of the at least two annular concave structures 6111 disposed closest to the object side, a distance between the valley point 6111a and the optical axis X is D, a distance between the concave end 6111b disposed close to the image side and the optical axis X is d, an elastic drafting ratio is defined as EDR, and EDR=[(D−d)/D]×100%. The aforementioned parameters can satisfy the following conditions listed in Table 6.

TABLE 6
6th Embodiment

| | | | |
|---|---|---|---|
| ψ (mm) | 1.651 | L (mm) | 0.9 |
| Z (mm) | 4.28 | a1 (mm) | 0.041 |
| ψ/Z | 0.386 | a2 (mm) | 0.092 |
| ψDo | 1.725 | a1/a2 | 0.446 |
| ψDi | 1.985 | D (mm) | 0.862 |
| (ψDi − ψDo)/ | 15.7 | d (mm) | 0.842 |
| ψ × 100% (%) | | | |
| ψs (mm) | 1.7 | EDR (%) | 2.3 |
| ψs/ψ | 1.03 | | |

### 7th Embodiment

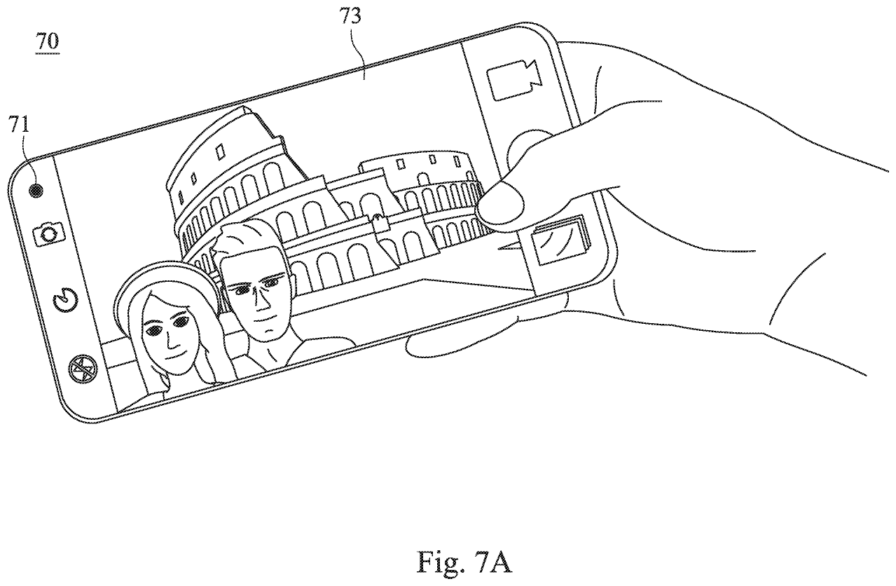

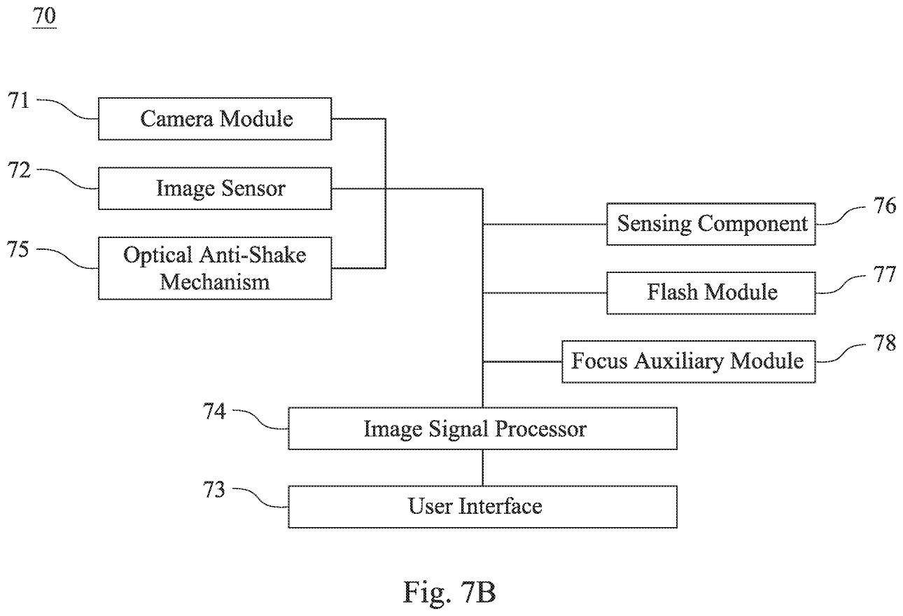

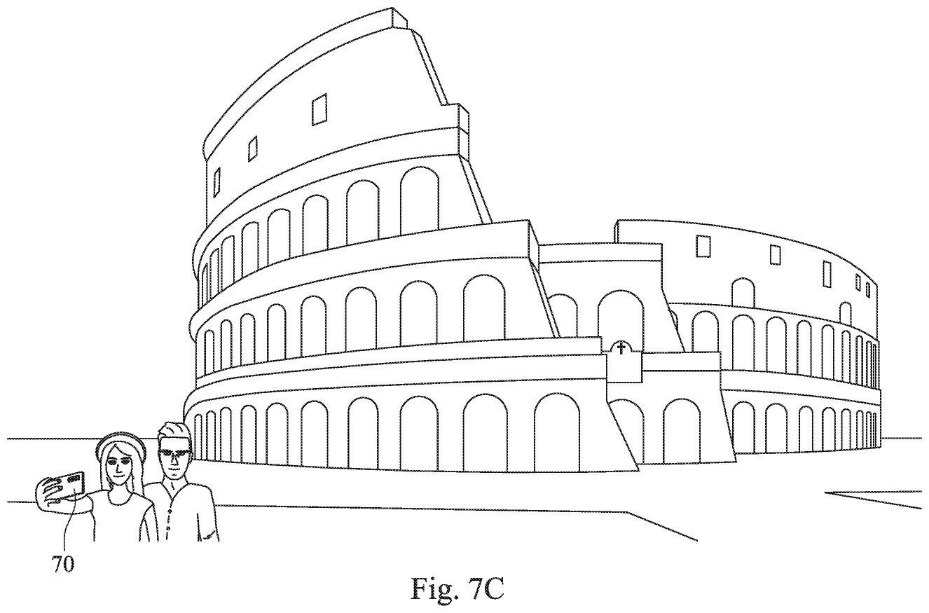

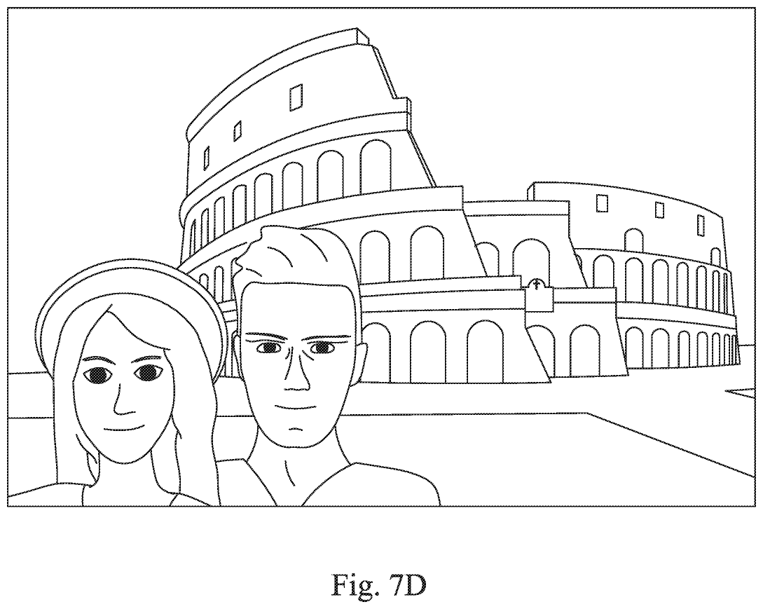

FIG. 7A is a schematic view of an electronic device 70 according to the 7th embodiment of the present disclosure. FIG. 7B is a block diagram of the electronic device 70 according to the 7th embodiment of FIG. 7A. As shown in FIG. 7A and FIG. 7B, the electronic device 70 a smartphone and includes a camera module 71, a user interface 73 and an image sensor 72. The camera module 71 of the 7th embodiment is disposed on a side region of the user interface 73, and the image sensor 72 is disposed on an image surface (not shown) of the camera module 71, wherein the user interface 73 can be a touch screen or a display screen, and the present disclosure is not limited thereto. The camera module 71 can be any one according to the 1st embodiment to the 6th embodiment, but the present disclosure is not limited thereto.

Specifically, the user can activate the capturing mode by the user interface 73 of the electronic device 70. At this moment, the camera module 71 collects imaging light on the image sensor 72 and outputs electronic signals associated with images to an image signal processor (ISP) 74.

Furthermore, in response to the camera specification of the electronic device 70, the electronic device 70 can further include an optical anti-shake mechanism 75, which can be an optical image stabilization (OIS) device. Moreover, the electronic device 70 can further include at least one auxiliary optical component (reference number is omitted) and at least one sensing component 76. In the 7th embodiment, the auxiliary optical component is a flash module 77 and a focus auxiliary module 78, the flash module 77 is for compensating the color temperature, and the focus auxiliary module 78 can be an infrared distance measurement component, a laser focus module, etc. The sensing component 76 can have functions for sensing physical momentum and kinetic energies, such as an accelerator, a gyroscope, and a hall effect element, so as to sense shaking or jitters applied by hands of the user or external environments. Thus the autofocus function and the optical anti-shake mechanism 75 of the camera module 71 disposed on the electronic device 70 can function to obtain great image quality and facilitate the electronic device 70 according to the present disclosure to have a capturing function with multiple modes, such as taking optimized selfies, high dynamic range (HDR) with a low light source, 4K resolution recording, etc. Furthermore, the user can visually see the captured image of the camera through the touch screen and manually operate the view finding range on the touch screen to achieve the auto focus function of what you see is what you get.

Furthermore, the electronic device 70 can further include, but not be limited to, a display, a control unit, a storage unit, a random-access memory (RAM), a read-only memory (ROM), or the combination thereof.

FIG. 7C is a schematic view of a selfies scene according to the 7th embodiment of FIG. 7A. FIG. 7D is a schematic view of an image according to the 7th embodiment of FIG. 7A. As shown in FIG. 7A to FIG. 7D, both of the camera module 71 and the user interface 73 are faced to the user. When the selfie mode or the live streaming mode is activated, the user can simultaneously see the captured image and operate the user interface 73. After shooting, the captured image as shown in FIG. 7D can be obtained. Therefore, the camera module 71 of the present disclosure can provide a better shooting experience.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A camera module, comprising:
a unitary element integrally formed by a lens carrier and a lens barrel and forming a containing space, wherein the unitary element has an object-side opening, and the object-side opening is a smallest opening of the unitary element;
an optical image lens assembly disposed in the containing space and having an optical axis;
a fixed member for accommodating the unitary element, wherein the fixed member comprises a base and a cover, and the cover has a through hole and is connected with the base; and
a driving member for driving the unitary element to move relative to the fixed member, wherein the driving member comprises at least one magnet and at least one coil, and one of the at least one magnet and the at least one coil is disposed on the fixed member and is corresponding to another one;
wherein the unitary element comprises a reverse inclined structure, the reverse inclined structure is located on an image side of the object-side opening and surrounds the optical axis, and the reverse inclined structure comprises:
at least two annular concave structures arranged in order from the object-side opening to an image side, wherein a sectional surface of each of the annular concave structures passing through the optical axis comprises a valley point and two concave ends, the two concave ends are respectively disposed on an object side and an image side of the valley point, and the valley point is located on a position farthest from the optical axis on each of the annular concave structures;
wherein the object-side opening is connected with one of the annular concave structures disposed closest to an object side, and two of the annular concave structures adjacent to each other are connected therewith;
wherein a diameter of the object-side opening is ψ, a total length of the unitary element along the optical axis is Z, and the following condition is satisfied:
0.30<ψZ<0.80.

2. The camera module of claim 1, wherein the reverse inclined structure is integrally formed on the unitary element.

3. The camera module of claim 1, wherein the driving member is configured to drive the unitary element to move relative to the fixed member in a direction substantially parallel to the optical axis.

4. The camera module of claim 1, further comprising:
another driving member configured to drive the unitary element to move relative to the fixed member in a direction substantially perpendicular to the optical axis.

5. The camera module of claim 1, wherein the unitary element further comprises an inlaying structure;
wherein the camera module further comprises:
at least one sensing magnet coupled with the inlaying structure of the unitary element; and
at least one position sensing component corresponding to the at least one sensing magnet, wherein the position sensing component is for detecting an amount of movement of the unitary element relative to the fixed member.

6. The camera module of claim 1, wherein the object-side opening is an aperture stop of the camera module.

7. The camera module of claim 1, further comprising:
a transparent plate disposed on an object side of the object-side opening, wherein the object-side opening of the unitary element is disposed closer to the transparent plate than the through hole of the cover.

8. The camera module of claim 1, wherein a part of the unitary element passes through and is protruded from the through hole, and the part of the unitary element comprises at least one reduction structure.

9. The camera module of claim 1, wherein the diameter of the object-side opening is ψ, the total length of the unitary element along the optical axis is Z, and the following condition is satisfied:
0.35<ψ/Z<0.70.

10. A camera module, comprising:
a unitary element integrally formed by a lens carrier and a lens barrel and forming a containing space, wherein the unitary element has an object-side opening, and the object-side opening is a smallest opening of the unitary element;
an optical image lens assembly disposed in the containing space and having an optical axis;
a fixed member for accommodating the unitary element, wherein the fixed member comprises a base and a cover, and the cover has a through hole and is connected with the base; and
a driving member for driving the unitary element to move relative to the fixed member, wherein the driving member comprises at least one magnet and at least one coil, and one of the at least one magnet and the at least one coil is disposed on the fixed member and is corresponding to another one;
wherein the unitary element comprises a reverse inclined structure, the reverse inclined structure is located on an image side of the object-side opening and surrounds the optical axis, and the reverse inclined structure comprises:
at least two annular concave structures arranged in order from the object-side opening to an image side, wherein a sectional surface of each of the annular concave structures passing through the optical axis comprises a valley point and two concave ends, the two concave ends are respectively disposed on an object side and an image side of the valley point, and the valley point is located on a position farthest from the optical axis on each of the annular concave structures;
wherein a diameter of the object-side opening is ψ, a diameter of the valley point of one of the at least two annular concave structures disposed closest to an object side is ψDo, a diameter of the valley point of one of the at least two annular concave structures disposed closest to the image side is ψDi, and the following condition is satisfied:
0.0%<(ψDi−ψDo)/ψ×100%<30%.

11. The camera module of claim 10, further comprising:
a light blocking sheet, wherein the reverse inclined structure is disposed between the light blocking sheet and the object-side opening, a distance between the light blocking sheet and the object-side opening along the optical axis is L, and the following condition is satisfied:
0.15 mm<L<1.4 mm.

12. The camera module of claim 11, wherein the light blocking sheet comprises a central opening, a diameter of the central opening of the light blocking sheet is ψs, the diameter of the object-side opening is ψ, and the following condition is satisfied:
0.9<ψs/ψ<1.1.

13. The camera module of claim 11, wherein the central opening of the light blocking sheet is an aperture stop of the camera module.

14. The camera module of claim 10, wherein the object-side opening is an aperture stop of the camera module.

15. The camera module of claim 10, wherein the diameter of the object-side opening is ψ, the diameter of the valley point of one of the at least two annular concave structures disposed closest to the object side is ψDo, the diameter of the valley point of one of the at least two annular concave structures disposed closest to the image side is ψDi, and the following condition is satisfied:
2.0%<(ψDi−ψDo)/ψ×100%<20%.

16. The camera module of claim 10, wherein the reverse inclined structure is integrally formed on the unitary element.

17. The camera module of claim 10, wherein the reverse inclined structure is gradually away from the optical axis from the object side to the image side substantially.

18. The camera module of claim 10, further comprising:
a transparent plate disposed on an object side of the object-side opening, wherein the object-side opening of the unitary element is disposed closer to the transparent plate than the through hole of the cover.

19. A camera module, comprising:
a unitary element integrally formed by a lens carrier and a lens barrel and forming a containing space, wherein the unitary element has an object-side opening, and the object-side opening is a smallest opening of the unitary element;
an optical image lens assembly disposed in the containing space and having an optical axis;
a fixed member for accommodating the unitary element, wherein the fixed member comprises a base and a cover, and the cover has a through hole and is connected with the base; and
a driving member for driving the unitary element to move relative to the fixed member, wherein the driving member comprises at least one magnet and at least one coil, and one of the at least one magnet and the at least one coil is disposed on the fixed member and is corresponding to another one;
wherein the unitary element comprises a reverse inclined structure, the reverse inclined structure is located on an image side of the object-side opening and surrounds the optical axis, and the reverse inclined structure comprises:
at least two annular concave structures arranged in order from the object-side opening to an image side, wherein a sectional surface of each of the annular concave structures passing through the optical axis comprises a valley point and two concave ends, the two concave ends are disposed on an object side and an image side of the valley point, respectively, and the valley point is located on a position farthest from the optical axis on each of the annular concave structures;
wherein a distance between each of the valley points and the concave end disposed on the image side thereof along the optical axis is a1, a distance between the two concave ends of each of the annular concave structures along the optical axis is a2, and following condition is satisfied:
0.05<a1/a2<0.90.

20. The camera module of claim 19, wherein the reverse inclined structure is integrally formed on the unitary element.

21. The camera module of claim 19, wherein a number of the at least two annular concave structures is N, and the following condition is satisfied:
2≤N≤15.

22. The camera module of claim 19, wherein in the two concave ends of each of the annular concave structures, the concave end disposed close to the image side of the valley point is away from the optical axis than the concave end disposed close to the object side thereof.

23. The camera module of claim 19, wherein in the one of the at least two annular concave structures disposed closest to an object side, a distance between the valley point and the optical axis is D, a distance between the concave end disposed close to the image side and the optical axis is d, an elastic drafting ratio is defined as EDR, and the following condition is satisfied:
0.0%<EDR<6.0%, wherein EDR=[(D−d)/D]×100%.

24. The camera module of claim 19, wherein the distance between each of the valley points and the concave end disposed on the image side thereof along the optical axis is a1, the distance between the two concave ends of each of the annular concave structures along the optical axis is a2, and following condition is satisfied:
0.10<a1/a2<0.70.

25. The camera module of claim 19, further comprising:
a transparent plate disposed on an object side of the object-side opening, wherein the object-side opening of the unitary element is disposed closer to the transparent plate than the through hole of the cover.

26. An electronic device, comprising:
the camera module of claim 19; and
an image sensor disposed on an image surface of the camera module.
